(19) United States
(12) Patent Application Publication
(10) Pub. No.: US 2012/0011886 A1
(43) Pub. Date: Jan. 19, 2012

(54) IONIC COMPOUNDS IN LITHIUM BROMIDE/WATER ABSORPTION CYCLE SYSTEMS

(76) Inventors: Mark Brandon Shiflett, Wilmington, DE (US); Konstantinos Kontomaris, Wilmington, DE (US); Steven Raymond Lustig, Landenberg, PA (US); Mark A. Scialdone, West Grove, PA (US); Megan Quigley, Aldan, PA (US); Berlyn R. Mellein, Wilmington, DE (US)

(21) Appl. No.: 13/259,229

(22) PCT Filed: Mar. 31, 2010
(86) PCT No.: PCT/US10/29322

§ 371 Date: Sep. 23, 2011

Related U.S. Application Data
(60) Provisional application No. 61/165,166, filed on Mar. 31, 2009.
(60) Provisional application No. 61/165,173, filed on Mar. 31, 2009.
(60) Provisional application No. 61/165,160, filed on Mar. 31, 2009.

(51) Int. Cl. F25B 15/00; C09K 5/04

(52) U.S. Cl. 62/476; 252/67

(57) ABSTRACT

Disclosed herein are compositions comprising lithium bromide, water, and at least one ionic compound. These compositions are useful as working fluids in absorption cycle systems. The ionic compound additive has been demonstrated to reduce crystallization in such absorption cycle systems.

This application claims priority under 35 U.S.C. §119(e) from, and claims the benefit of, U.S. Provisional Application No. 61/165,160 (filed Mar. 31, 2009); U.S. Provisional Application No. 61/165,166 (filed Mar. 31, 2009); and U.S. Provisional Application No. 61/165,173 (filed Mar. 31, 2009); each of which is by this reference incorporated in its entirety as a part hereof for all purposes.

### TECHNICAL FIELD

This disclosure relates to lithium bromide/water absorption cycle systems, and to the use therein of crystallization-suppressing additives.

### BACKGROUND

A significant percentage of the world's commercial air conditioning and industrial refrigeration equipment is based on the use of absorption cycle systems. Most of these systems use water as the refrigerant and a lithium halide (e.g., LiBr) as the absorbent. Unfortunately, in normal practice, lithium bromide hydrates are prone to crystallization in regions of the equipment where the local operating temperatures and lithium bromide concentrations are close to, and sometimes inadvertently fall below, the crystallization curve. Precipitation of lithium bromide salts from lithium bromide/water solutions thus limits the range of feasible operating conditions, limits the energy efficiency of the absorption cycle, and prevents use of innovations, such as air-cooled condensers and absorbers. Air-cooled operation eliminates the need for water cooling towers and their associated first costs, operating costs, maintenance costs, space requirements, and consumption of large quantities of water (a limited resource in many areas of the world).

Although U.S. Pat. No. 5,846,450 discloses the use of potassium formate in absorption systems, a need still remains for absorption cycle systems that are not limited by crystallization and can operate in the most energy efficient modes possible.

### SUMMARY

Disclosed herein is a composition comprising lithium bromide, water and at least one ionic compound that includes:

at least one cation selected from the group consisting of the cations represented by the structures of the following formulae:

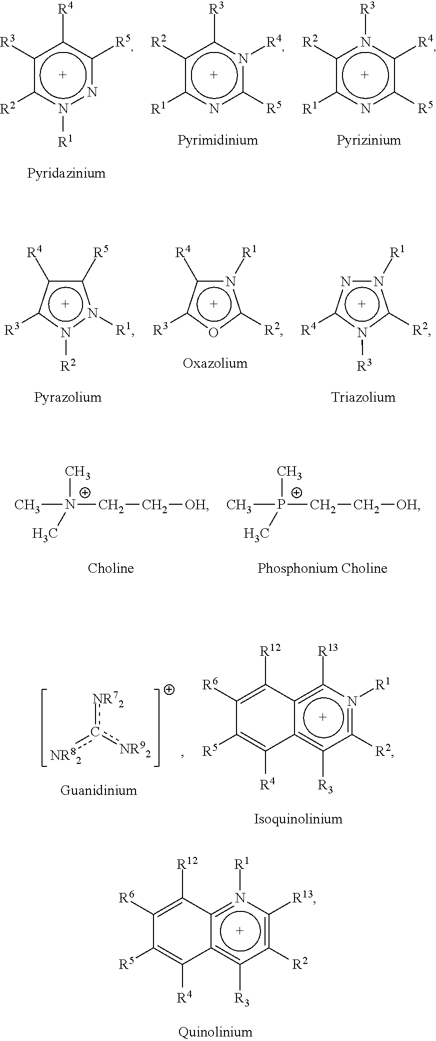

and mixtures thereof;

wherein R¹, R², R³, R⁴, R⁵, R⁶, R¹² and R¹³ are independently selected from the group consisting of:

### (i) H,

(ii) halogen,
(iii) —CH₃, —C₂H₅, or C₃ to C₂₅ straight-chain, branched or cyclic alkane or alkene,
(iv) —CH₃, —C₂H₅, or C₃ to C₂₅ straight-chain, branched or cyclic alkane or alkene comprising one to three heteroatoms selected from the group consisting of O, N, Si and S;
(v) C₆ to C₂₀ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene,

### (2) OH,

### (3) NH₂, and

### (4) SH; and

wherein R⁷, R⁸, and R⁹ are independently selected from the group consisting of:

(i) —CH₃, —C₂H₅, or C₃ to C₂₅ straight-chain, branched or cyclic
(ii) alkane or alkene, optionally substituted with at least one member selected from the group consisting of Cl, Br, F, I, OH, NH₂ and SH;
(iii) —CH₃, —C₂H₅, or C₃ to C₂₅ straight-chain, branched or cyclic
(iv) alkane or alkene comprising one to three heteroatoms selected from the group consisting of O, N, Si and S,
(v) C₆ to C₂₅ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene,

### (2) OH,

### (3) NH₂, and

### (4) SH.

Also disclosed herein is a composition comprising lithium bromide, water, and at least one ionic compound comprising at least one cation and at least one anion, wherein the cation is selected from the group consisting of lithium, sodium, potassium, cesium, rubidium and cations as represented by the structures of the following formulae:

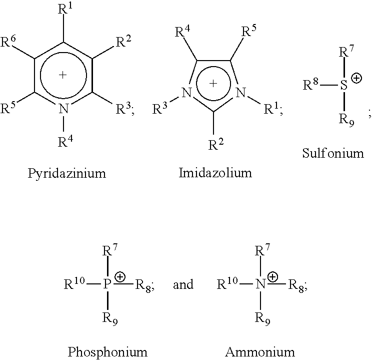

and mixtures thereof;

wherein R¹, R², R³, R⁴, R⁵, and R⁶ are independently selected from the group consisting of:

### (i) H,

(ii) halogen,
(iii) —CH₃, —C₂H₅, or C₃ to C₂₅ straight-chain, branched or cyclic alkane or alkene,
(vii) —CH₃, —C₂H₅, or C₃ to C₂₅ straight-chain, branched or cyclic alkane or alkene comprising one to three heteroatoms selected from the group consisting of O, N, Si and S,
(iv) C₆ to C₂₀ unsubstituted aryl, or C₃ to C₂₅ unsubstituted heteroaryl having one to three heteroatoms independently selected from the group consisting of O, N, Si and S, and
(v) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene,

### (2) OH,

### (3) NH₂, and

### (4) SH; and

wherein R⁷, R⁸, R⁹, and R¹⁰ are independently selected from the group consisting of:

(i) —CH₃, —C₂H₅, or C₃ to C₂₅ straight-chain, branched or cyclic alkane or alkene,
(ii) —CH₃, —C₂H₅, or C₃ to C₂₅ straight-chain, branched or cyclic alkane or alkene comprising one to three heteroatoms selected from the group consisting of O, N, Si and S,
(iii) C₆ to C₂₅ unsubstituted aryl, or C₃ to C₂₅ unsubstituted heteroaryl having one to three heteroatoms independently selected from the group consisting of O, N, Si and S, and
(iv) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,

### (2) OH,

### (3) NH₂, and

### (4) SH; and

wherein the anion is selected from one or more members of the group consisting of [HCO₂]⁻, [CH₃CO₂]⁻, [HSO₄]⁻, [CH₃OSO₃]⁻, [C₂H₅OSO₃]⁻, [AlCl₄], [CO₃]²⁻, [HCO₃]⁻, [NO₂]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, I⁻, BR¹R²R³R⁴, BOR¹OR²OR³OR⁴, carborates [1-carbadodecaborate(1-)], optionally substituted with alkyl or substituted alkyl, carboranes [dicarbadodecaborate(1-)]; and anions as represented by the structure of the following formula:

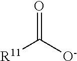

and mixtures thereof;

wherein R¹¹ is selected from the group consisting of:

(i) —H, —CH₃, —C₂H₅, or C₃ to C₁₀ straight-chain, branched or cyclic alkane or alkene;
(ii) —CH₃, —C₂H₅, or C₃ to C₁₀ straight-chain, branched or cyclic alkane or alkene comprising one to three heteroatoms selected from the group consisting of O, N, Si and S,
(iii) C₆ to C₁₀ unsubstituted aryl, or C₃ to C₁₀ unsubstituted heteroaryl having one to three heteroatoms independently selected from the group consisting of O, N, Si and S; and
(iv) C₆ to C₁₀ substituted aryl, or C₃ to C₁₀ substituted heteroaryl having one to three heteroatoms independently selected from the group consisting of O, N, Si and S; and
wherein the substituted aryl or substituted heteroaryl has one to three substituents independently selected from the group consisting of:
   (1) —CH₃, —C₂H₅, or C₃ to C₁₀ straight-chain, branched or cyclic alkane or alkene, (2) OH,

### (3) NH₂, and

### (4) SH.

Also disclosed herein is a composition comprising lithium bromide, water, and at least one ionic compound selected from the group consisting of:
N,N-dimethylethanolammonium propanoate;
bis(2-methoxyethyl)ammonium acetate;
choline glycolate;
N,N-dimethylethanolammonium acetate;
1,2,4-trimethylpyrazolium methylsulfate;
tris-(2-hydroxyethyl)-methylammonium methylsulfate;
tetramethylammonium formate;
1-butyl-3-methylimidazolium 1,1,2-trifluoro-2-(perfluoroethoxy)ethanesulfonate;
tetradecyl(tri-n-butyl)phosphonium 1,1,2, 3, 3, 3-hexafluoropropanesulfonate;
1-butyl-3-methylimidazolium levulinate;
1-butyl-3-methylimidazolium dihydrogen phosphite;
1-butyl-3-methylimidazolium methylsulfate;
1-butyl-3-methylimidazolium acetate;
choline levulinate;
1-butyl-1-methylpyrrolidinium trifluoroacetate;
tetramethylammonium dichloroacetate;
sodium glycolate;
tetrabutylphosphonium succinamate;
tetradecyl(tri-n-butyl)phosphonium 1,1,2,2-tetrafluoroethanesulfonate; choline 1,1,2,2-tetrafluoroethanesulfonate;
lithium acetate;
tetramethylammonium pyruvate;
N,N-dimethylethanolammonium glycolate;
1-ethyl-3-methylimidazolium dihydrogen phosphite;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoro acetate;
diethanolammonium trifluoro acetate;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoroacetate;
diethanolammonium trifluoroacetate;
1-ethyl-3-methylimidazolium 1,1,2,2-tetrafluoroethanesulfonate;
1-butyl-2,3-dimethylimidazolium 1,1,2,2-tetrafluoroethanesulfonate;
1-butyl-3-methylimidazolium 1,1,2,3,3,3-hexafluoropropanesulfonate;
1-octyl-3-methylimidazolium 1,1,2,2-tetrafluoroethanesulfonate;
1-butyl-3-methylimidazolium 1,1,2,2-tetrafluoroethanesulfonate;
tetra(hydroxyethyl)ammonium 1,1,2,2-tetrafluoroethanesulfonate;
tetradecyl(trihexyl)phosphonium nonafluorobutanesulfonate;
1-(N,N,N-dimethylpropylaminoethyl)-5-methylpyrrolidine-2-one levulinate;
1-butyl-3-methylimidazolium 1,1,2-trifluoro-2-(trifluoromethoxy)ethanesulfonate;
1,3-dimethylimidazolium levulinate;
1-ethyl-3-methylimidazolium levulinate;
1,3-dimethylimidazolium 1,1,2-trifluoro-2-(perfluoroethoxy)ethanesulfonate;
tetrabutylphosphonium 1,1,2-trifluoro-2-(trifluoromethoxy)ethanesulfonate;
1-ethyl-3-methylimidazolium ascorbate;
tetramethylammonium tropolonate;
trimethylbenzylammonium phosphonoacetate;
tetramethylammonium levulinate; and mixtures thereof.

This invention further provides for the execution or performance of an absorption cycle by operating or running a temperature adjustment device that is suitable to accomplish heating or cooling in view of the heat rejected and absorbed during the repetition of the cycle.

In one further embodiment hereof, this invention provides a temperature adjustment device that executes an absorption cycle, wherein the working fluid comprises a composition as described herein.

In yet another embodiment hereof, this invention provides a method of adjusting the temperature of an object, medium or a space comprising executing an absorption cycle in a device located adjacent to the object, medium or space, wherein water is absorbed into an aqueous solution of a lithium halide and an ionic compound as described herein.

In yet another embodiment hereof, this invention provides, in an aqueous solution of a lithium halide, a method of decreasing either or both of the temperature at which the onset of crystallization in the solution occurs, or the temperature at which the solution freezes, comprising admixing with the solution an additive comprising an ionic compound as described herein.

### BRIEF DESCRIPTION OF THE DRAWINGS

FIG. 1 is a schematic diagram of one embodiment of an absorption cycle system, specifically a system for cooling.

### DETAILED DESCRIPTION

Before addressing details of embodiments described below, some terms are defined or clarified, as follows:

A heat transfer medium (also referred to herein as a heat transfer fluid, a heat transfer composition or a heat transfer fluid composition) is a working fluid used to carry heat from a heat source to a heat sink

A refrigerant is a compound or mixture of compounds that function as a heat transfer fluid in a cycle wherein the fluid sometimes undergoes a phase change from a liquid to a gas and back. In absorption cycle systems, a refrigerant is the volatile component of a working fluid pair.

A working fluid pair is a pair of fluids comprising an absorbent and a refrigerant used to provide the cooling or heating in an absorption cycle system. In general, the working fluids will have an affinity for one another, e.g. solubility of one in the other.

An absorbent is a working fluid that is the non-volatile component of a working fluid pair as used in an absorption cycle system.

An absorption cycle system is any system that produces heating or cooling by use of a working fluid pair and the absorption effect as described herein. In one embodiment, an absorption cycle system comprises an absorption chiller that produces cooling. In another embodiment, an absorption cycle system comprises an absorption heat pump that may produce heat or cooling. In another embodiment, an absorption cycle system comprises an absorption heater. Absorption cycle systems are used to provide cooling or heating in areas where electricity is in sort supply relative to natural gas or other fuel sources that can drive absorption systems. Additionally, absorption cycle systems can be driven by available waste heat thus improving overall efficiency in energy use.

In some embodiments, lithium bromide may contain other lithium halides, including lithium fluoride, lithium chloride, lithium iodide and mixtures thereof. The amounts of the other lithium halides present in lithium bromide is expected to be low with the most prevalent being the chloride. In some embodiments, lithium bromide exists as a hydrate.

In one embodiment, an ionic compound is any chemical compound comprising a cation and an anion, other than lithium bromide. In another embodiment, an ionic compound comprises any ionic chemical compound that is solid at room temperature. In yet another embodiment, an ionic compound comprises an ionic liquid.

In one embodiment, ionic liquids are organic ionic compounds that are liquid at temperatures below 100° C. They differ from other ionic compounds in that they have low melting points and they tend to be liquid over a wide temperature range. Ionic liquids have essentially no vapor pressure, and they can either be neutral, acidic or basic. The properties of an ionic liquid can be tailored by varying the cation and anion. A cation or anion of an ionic liquid useful for the present invention can, in principle, be any cation or anion such that the cation and anion together form an organic compound that is liquid at or below about 100° C.

In one embodiment, ionic liquids are formed by reacting a nitrogen-containing heterocyclic ring, preferably a heteroaromatic ring, with an alkylating agent (for example, an alkyl halide) to form a quaternary ammonium salt, and performing ion exchange or other suitable reactions with various Lewis acids or their conjugate bases to form the ionic liquid. Examples of suitable heteroaromatic rings include substituted pyridines, imidazole, substituted imidazole, pyrrole and substituted pyrroles. These rings can be alkylated with virtually any straight, branched or cyclic C₁₋₂₀ alkyl group, but preferably, the alkyl groups are C₁₋₁₆ groups. Various triarylphosphines, thioethers and cyclic and non-cyclic quaternary ammonium salts may also been used for this purpose. Counterions that may be used include chloroaluminate; bromoaluminate; gallium chloride, tetrafluoroborate, tetrachloroborate, hexafluorophosphate, nitrate, trifluoromethanesulfonate; methylsulfonate; p-toluenesulfonate; hexafluoroantimonate; hexafluoroarsenate; tetrachloroaluminate; tetrabromoaluminate; perchlorate, hydroxide anion, copper dichloride anion, iron trichloride anion, zinc trichloride anion, as well as various lanthanum, potassium, lithium, nickel, cobalt, manganese, and other metal-containing anions.

In another embodiment, ionic liquids may also be synthesized by salt metathesis, by an acid-base neutralization reaction or by quaternizing a selected nitrogen-containing compound; or they may be obtained commercially from several companies such as Merck (Darmstadt, Germany) or BASF (Mount Olive, N.J.).

Representative examples of ionic liquids useful herein included among those that are described in sources such as J. Chem. Tech. Biotechnol., 68:351-356 (1997); Chem. Ind., 68:249-263 (1996); J. Phys. Condensed Matter, 5: (supp 34B):B99-B 106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references therein cited). In one embodiment, a library, i.e. a combinatorial library, of ionic liquids may be prepared, for example, by preparing various alkyl derivatives of a quaternary ammonium cation, and varying the associated anions. The acidity of the ionic liquids can be adjusted by varying the molar equivalents and type and combinations of Lewis acids.

### Compositions

In one embodiment hereof, there is disclosed a composition comprising:

a) lithium bromide;
b) water; and

at least one ionic compound comprising at least one cation selected from the group consisting of cations as represented by the structures of the following formulae:

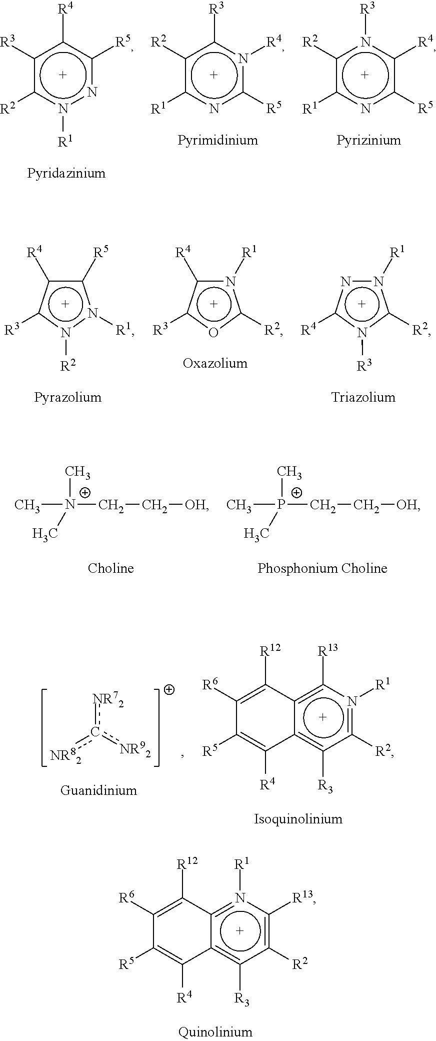

and mixtures thereof;

wherein R¹, R², R³, R⁴, R⁵, R⁶, R¹² and R¹³ are independently selected from the group consisting of:

### (i) H,

### (ii) Halogen,

(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,

### (2) OH,

### (3) NH₂, and

### (4) SH; and

R⁷, R⁸, and R⁹ are independently selected from the group consisting of:

(i) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₂₅ unsubstituted aryl, or C₃ to C₂₅ unsubstituted heteroaryl having one to three heteroatoms independently selected from the group consisting of O, N, Si and S, and
(iv) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,

### (2) OH,

### (3) NH₂, and

### (4) SH; and

wherein optionally at least two of R¹, R², R³, R⁴, R⁵, R⁶, R⁷, R⁸, and R⁹ can together form a cyclic or bicyclic alkanyl or alkenyl group.

In one particular embodiment, ionic compounds include those having anions selected from the following, and mixtures thereof: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, Cl⁻, Br⁻, I⁻, SCN⁻; BR¹R²R³R⁴, BOR¹OR²OR³OR⁴, carborates (1-carbadodecaborate(1-)), optionally substituted with alkyl or substituted alkyl, carboranes (dicarbadodecaborate(1-)) optionally substituted with alkylamine, substituted alkylamine, alkyl or substituted alkyl, any fluorinated anion, and mixtures thereof.

In another particular embodiment, any fluorinated anion includes [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃], [CF₃CF₂OCFHCF₂SO₃]⁻, [CF₃CFHOCF₂CF₂SO₃]⁻, [CF₂HCF₂OCF₂CF₂SO₃]⁻, [CF₂₁CF₂OCF₂CF₂SO₃]⁻, [CF₃CF₂OCF₂CF₂SO₃]⁻, [(CF₂HCF₂SO₂)₂N], [(CF₃CFHCF₂SO₂)₂N]⁻; and F⁻.

In another embodiment, there is disclosed herein ionic compounds that include those with anions of the Formula:

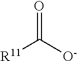

wherein R¹¹ is selected from the group consisting of:

(i) —H, —CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₃ to C₁₀ unsubstituted heteroaryl having one to three heteroatoms independently selected from the group consisting of O, N, Si and S, and
(iv) C₆ to C₁₀ substituted aryl, or C₃ to C₁₀ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,

### (2) OH,

### (3) NH₂, and

### (4) SH.

In another particular embodiment, anions may include levulinates. A levulinate ion is an anion represented by the structure of the following formula:

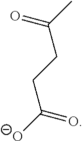

In yet another embodiment, there is disclosed herein a composition comprising:

a) lithium bromide,
b) water, and
c) at least one ionic compound comprising at least one cation and at least one anion, wherein the cation is selected from the group consisting of lithium, sodium, potassium, cesium, rubidium; and cations as represented by the structures of the following formulae:

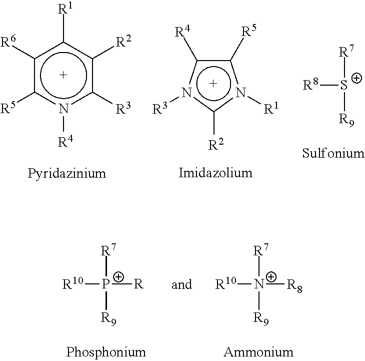

and mixture thereof;

wherein R¹, R², R³, R⁴, R⁵, and R⁶ are independently selected from the group consisting of:

### (i) H,

(ii) halogen,
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,

### (2) OH,

### (3) NH₂, and

### (4) SH;

wherein R⁷, R⁸, R⁹, and R¹⁰ are independently selected from the group consisting of:

(i) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₂₅ unsubstituted aryl, or C₃ to C₂₅ unsubstituted heteroaryl having one to three heteroatoms independently selected from the group consisting of O, N, Si and S; and
(iv) C₆ to C₂₅ substituted aryl, or C₃ to C₂₅ substituted heteroaryl having one to three heteroatoms independently selected from the group consisting of O, N, Si and S; and

wherein the substituted aryl or substituted heteroaryl has one to three substituents independently selected from the group consisting of:

(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,

### (2) OH,

### (3) NH₂, and

### (4) SH; and

wherein optionally at least two of R¹, R², R³, R⁴, R⁵, R⁶, R⁷, R⁸, R⁹, and R¹⁰ can together form a cyclic or bicyclic alkanyl or alkenyl group.

The anion is selected from the group consisting of:

[CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [No₃]⁻, [SO₄]²⁻, [PO₃]³⁻, [HPO₃]², [H₂PO₃]¹⁻, [PO₄]³⁻, [HPO₄]²⁻, [H₂PO₄]⁻, [HSO₃]⁻, [CuCl₂]⁻, I⁻, BR¹R²R³R⁴, BOR¹OR²OR³OR⁴, carborates (1-carbadodecaborate(1-)), optionally substituted with alkyl or substituted alkyl, carboranes (dicarbadodecaborate(1-)) optionally substituted with alkylamine, substituted alkylamine, alkyl or substituted alkyl;
fluorinated anions selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂₁CF₂OCF₂CF₂SO₃]⁻, [CF₃CF₂OCF₂CF₂SO₃]⁻, [(CF₂HCF₂SO₂)₂N]_, [(CF₃CFHCF₂SO₂)₂N]⁻, F⁻, and
anions of the formula:

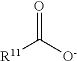

wherein R¹¹ is selected from the group consisting of:

(i) —H, —CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₃ to C₁₀ unsubstituted heteroaryl having one to three heteroatoms independently selected from the group consisting of O, N, Si and S; and
(iv) C₆ to C₁₀ substituted aryl, or C₃ to C₁₀ substituted heteroaryl having one to three heteroatoms independently selected from the group consisting of O, N, Si and S; and

wherein the substituted aryl or substituted heteroaryl has one to three substituents independently selected from the group consisting of:

(1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,

### (2) OH,

### (3) NH₂, and

### (4) SH;

and mixtures thereof.

In one particular embodiment, anions may include levulinates. A levulinate ion is an anion represented by the structure of the following formula:

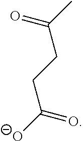

In another embodiment hereof, there is disclosed herein is a composition comprising:
a. lithium bromide;
b. water; and
c. at least one ionic compound selected from the group consisting of:
N,N-dimethylethanolammonium propanoate; bis(2-methoxyethyl)ammonium acetate; choline glycolate;
N,N-dimethylethanolammonium acetate;
1,2,4-trimethylpyrazolium methylsulfate;
tris-(2-hydroxyethyl)-methylammonium methylsulfate; tetramethylammonium formate;
1-butyl-3-methylimidazolium 1,1,2-trifluoro-2-(perfluoroethoxy)ethanesulfonate; tetradecyl(tri-n-butyl)phosphonium 1,1,2,3,3,3-hexafluoropropanesulfonate;
1-butyl-3-methylimidazolium levulinate;
1-butyl-3-methylimidazolium dihydrogen phosphite;
1-butyl-3-methylimidazolium methylsulfate;
1-butyl-3-methylimidazolium acetate;
choline levulinate;
1-butyl-1-methylpyrrolidinium trifluoroacetate;
tetramethylammonium dichloroacetate;
sodium glycolate;
tetrabutylphosphonium succinamate;
tetradecyl(tri-n-butyl)phosphonium 1,1,2,2-tetrafluoroethanesulfonate;
choline 1,1,2,2-tetrafluoroethanesulfonate;
lithium acetate;
tetramethylammonium pyruvate;
N,N-dimethylethanolammonium glycolate;
1-ethyl-3-methylimidazolium dihydrogen phosphite;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoroacetate;
diethanolammonium trifluoro acetate;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoro acetate;
diethanolammonium trifluoro acetate;
1-ethyl-3-methylimidazolium 1,1,2,2-tetrafluoroethanesulfonate;
1-butyl-2,3-dimethylimidazolium 1,1,2,2-tetrafluoroethanesulfonate;
1-butyl-3-methylimidazolium 1,1,2,3,3,3-hexafluoropropanesulfonate;
1-octyl-3-methylimidazolium 1,1,2,2-tetrafluoroethanesulfonate;
1-butyl-3-methylimidazolium 1,1,2,2-tetrafluoroethanesulfonate;
tetra(hydroxyethyl)ammonium 1,1,2,2-tetrafluoroethanesulfonate;
tetradecyl(trihexyl)phosphonium nonafluorobutanesulfonate;
1-(N,N,N-dimethylpropylaminoethyl)-5-methylpyrrolidine-2-one levulinate;
1-butyl-3-methylimidazolium 1,1,2-trifluoro-2-(trifluoromethoxy)ethanesulfonate;
1,3-dimethylimidazolium levulinate;
1-ethyl-3-methylimidazolium levulinate;
1,3-dimethylimidazolium 1,1,2-trifluoro-2-(perfluoroethoxy)ethanesulfonate;
tetrabutylphosphonium 1,1,2-trifluoro-2-(trifluoromethoxy)ethanesulfonate;
1-ethyl-3-methylimidazolium ascorbate;
tetramethylammonium tropolonate;
trimethylbenzylammonium phosphonoacetate;
tetramethylammonium levulinate; and mixtures thereof.

The ionic compounds listed above may be available commercially or may be prepared by methods as described herein.

In compositions as disclosed herein, the amounts of lithium bromide, water and the ionic compound may vary. In one embodiment, the compositions comprise from about 30 weight percent to about 85 weight percent lithium bromide in water. In another embodiment, the compositions comprise from about 40 weight percent to about 75 weight percent lithium bromide in water. In another embodiment, the compositions comprise from about 55 weight percent to about 70 weight percent lithium bromide in water.

In one embodiment, compositions as disclosed herein, contain from about 10 parts per million by mole (ppm) to about 50,000 ppm of ionic compound(s) with respect to the LiBr in the composition. In another embodiment, the compositions contain from about 100 ppm to about 10,000 ppm of ionic compound(s) with respect to the LiBr in the composition. In another embodiment, the compositions contain from about 1000 ppm to about 5000 ppm of ionic compound(s) with respect to the LiBr in the composition.

In one embodiment, the compositions disclosed herein contain from about 1 weight percent to about 15 weight percent of the ionic compound(s) based on the total composition. In another embodiment, the compositions disclosed herein contain from about 5 weight percent to about 12 weight percent of the ionic compound(s) based on the total composition. In another embodiment, the compositions disclosed herein contain from about 8 weight percent to about 12 weight percent of the ionic compound(s) based on the total composition.

In one embodiment, the compositions disclosed herein may comprise additional compounds selected from the group consisting of: salts of bromine; salts of alkali metals, phosphates, chlorates, bromates, iodates, ferrocyanides, chlorides; crown ethers, monocarboxylic acids, polycarboxylic acids, diphosphonic acids, polyphosphoric acids, phosphates; and combinations thereof.

In another embodiment, additional compounds include potassium bromate, potassium ferrocyanide, ethylene diamine tetraacetic acid (EDTA), phosphoric acid, malonic acid, malic acid, potassium iodate, adenosine triphosphate (ATP), adenosine diphosphate (ADP), 5-amino-2,4,6-trioxo-1,3-perhydrodizine-N,N-diacetic acid (uramil-N,N-diacetic acid), polyphosphoric acid (poly PA), 1-hydroxyethylidene-1,1-diphosphonic acid (HEDP), diethylene triamine penta(methylene phosphonic acid) (DTPMP), amino tri(methylene phosphonic acid) (ATMP), pyrophosphoric acid (PPA), methylene diphosphonic acid (MDPA), and combinations including one or more of the above.

In one embodiment, these additional compounds may be present in the disclosed compositions in the same amounts as the ionic compounds. In another embodiment, these additional compounds may be present in the disclosed compositions in greater amounts than the ionic compounds. In yet another embodiment, these additional compounds may be present in the disclosed compositions in amounts less than the ionic compounds.

Other additives may be included in the compositions as disclosed herein. Such additives include, for instance, corrosion inhibitors (for example, molybdate), alkaline treating agents (for example, lithium hydroxide), antifoaming agents including alcohols and glycols, and any other additive known in the art to be used in working fluids for absorption cycle systems.

In one embodiment, the compositions disclosed herein may be prepared by any convenient method to combine the desired amounts of the individual components. A preferred method is to weigh the desired component amounts and thereafter combine the components in an appropriate vessel. Agitation may be used, if desired. Additionally, heat may be applied to speed the dissolution of the various components.

### Methods of Use

In one embodiment, disclosed herein are refrigerant and absorbent compositions containing an ionic compound additive that may be useful for a wide range of absorption cycle applications, including, but not limited to refrigeration, air conditioning, heating and power generation. In particular, the LiBr/water systems containing the ionic compound additive may be used in absorption chillers (for comfort air conditioning) and heat pumps (for heating and cooling). Additionally, the use of the ionic compound additive may enable use of LiBr/water absorption systems in new and different cooling or heating applications, all of which are intended to be included in the scope of the present description.

As stated previously, the compositions comprising lithium bromide, water, and ionic compound are useful in the execution of an absorption cycle.

The incorporation of the ionic compound into the LiBr/water working fluid of the absorption cycle system is expected to shift the LiBr concentration-temperature crystallization curve to higher LiBr concentrations and lower temperatures. Therefore, it should allow more reliable operation of the system over wider ranges of LiBr concentrations and temperatures without crystallization of the LiBr. Additionally, application of absorption cooling to lower temperature applications may be possible if the system is able to operate at a lower temperature without crystallization of the lithium bromide.

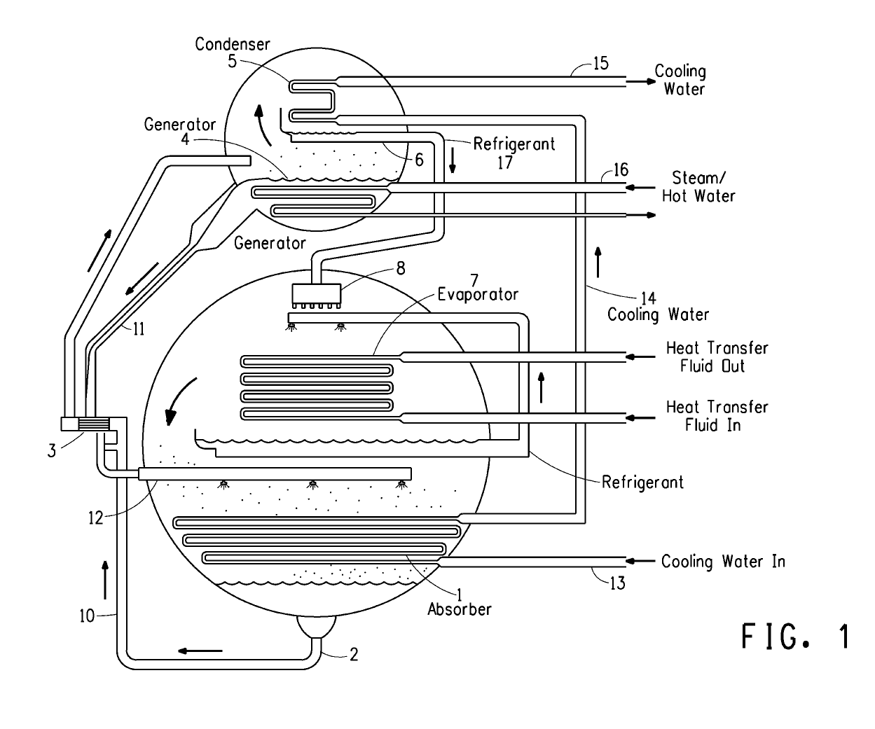

A schematic diagram for one embodiment, of a simple absorption cooling system is shown in FIG. 1. The system is composed of a condenser and an evaporator with an expansion device similar to equipment used in an ordinary vapor compression cycle, but an absorber-generator solution circuit replaces the compressor. The absorber-generator solution circuit may be composed of an absorber, a generator, a heat exchanger, a pressure control device (or expansion device) and a pump for circulating the solution.

In a typical absorption cycle system, transfer of the water refrigerant from the evaporator to the condenser is accomplished by absorbing and then releasing water vapor into and out of a lithium bromide (e.g., LiBr) solution. LiBr/water absorption systems operate at a partial vacuum (about 1/100^{th} of normal atmospheric pressure) to cause water to vaporize at a cold enough temperature (about 40° F.) to produce chilled water at about 44° F.

Referring to FIG. 1, an absorption cycle can be described. The high refrigerant absorbent/refrigerant solution collects in the bottom of an absorber 1. A pump 2 is used to move the high refrigerant absorbent/refrigerant solution via line 10 through a (shell and tube type) heat exchanger 3 for pre-heating (the low-refrigerant absorbent/refrigerant solution from the generator provides the heat as will be described later herein). After exiting the heat exchanger, the high refrigerant absorbent/refrigerant solution moves into the generator 4. Within the generator is a bundle of tubes which carry combustion gases, steam, or hot water, via line 16. The combustion gases, steam, or hot water transfers heat into the high refrigerant absorbent/refrigerant solution. The heat causes the absorbent/refrigerant solution to release refrigerant vapor into a condenser 5 leaving a low refrigerant absorbent/refrigerant solution behind. The refrigerant is now a high pressure vapor. Some amount of refrigerant remains in the absorbent/refrigerant solution, but the amount of refrigerant is lower than in the high refrigerant absorbent/refrigerant solution that leaves the absorber. The low refrigerant content absorbent/refrigerant solution moves via line 11 into the heat exchanger 3 where it is cooled by the high refrigerant content absorbent/refrigerant solution being pumped out of the absorber. The low refrigerant content absorbent/refrigerant solution moves from the heat exchanger to the absorber via line 12 and collects in the bottom of the absorber where it started the cycle.

Cooling water is provided to the condenser and the refrigerant vapor condenses to form refrigerant liquid in the condenser. The refrigerant liquid moves from the condenser via line 17 to the evaporator 7 through an expansion device 8 that partially evaporates the refrigerant liquid. The partially evaporated refrigerant liquid enters the evaporator which has water or some other heat transfer fluid flowing therethrough. The water or heat transfer fluid is cooled as the liquid refrigerant is evaporated forming refrigerant vapor. The cooled water or heat transfer fluid is circulated back to a body to be cooled, such as a building, thus providing the cooling effect as desired, for instance, for air conditioning. The refrigerant vapor moves to the absorber from the evaporator. The high affinity of the absorbent for the refrigerant causes the refrigerant to be dissolved into the absorbent/refrigerant solution. The absorption of the refrigerant into the absorbent also generates heat (heat of absorption). Cooling water moves through the tube bundles of the absorber to remove this heat of absorption from the system. The solution collecting at the bottom of the absorber is again a high refrigerant absorbent/refrigerant solution that will begin the cycle again.

Cooling water is used in both the absorber and condenser as described above. The cooling water will flow into the system at the absorber through line 13, wherein it warms slightly due to the heat of solution of the refrigerant dissolving into the absorbent. From the absorber, the cooling water will move via line 14 to the condenser tube bundle wherein it will provide the cooling to condense the refrigerant vapor to refrigerant liquid. The cooling water is thus heated somewhat again and from the condenser flows via line 15 to a cooling tower or other device intended to release the heat picked up in the system to the atmosphere and provide cooled water again to the system.

The hot water, steam, or combustion gasses supplied to the generator in order to release refrigerant vapor from the absorbent/refrigerant solution may be supplied by any number of sources, including water heated with waste heat from a combustion engine (combustion gases) and solar heated water, among others.

In one embodiment, disclosed herein is a process for producing cooling comprising forming a refrigerant/absorbent mixture, heating the mixture

to release refrigerant vapor, condensing the refrigerant to form liquid refrigerant, evaporating the liquid refrigerant in the vicinity of a heat transfer fluid, transferring the heat transfer fluid to the vicinity of a body to be cooled, and reforming the absorbent/refrigerant solution; wherein the absorbent/refrigerant solution comprises a composition as disclosed herein containing lithium bromide, water and at least one ionic compound.

A body to be cooled may be any space, location, object or body which it is desirable to cool, including the interior spaces of buildings requiring air conditioned or refrigerated spaces, in for instance hotels or restaurants, or industrial process areas.

In another embodiment, in a similar manner to the process described above to produce cooling, an absorption cycle may be used to generate heat with for instance an absorption heat pump. In this process the heat of solution generated by dissolving the refrigerant into the absorbent in the absorber and the heat of condensation generated by condensing the refrigerant vapor to refrigerant liquid in the condenser can be transferred to water or some other heat transfer fluid, which is used to heat any space, location, object or body.

In one embodiment, is provided a method for controlling crystallization in a refrigerant fluid comprising water and lithium bromide, the method comprising adding to the refrigerant fluid an ionic compound as disclosed herein.

In another embodiment, is provided a method for lowering the lower temperature limit of an absorption cycle system, the method comprising providing as working fluid for the system a composition as disclosed herein, wherein the composition comprising lithium bromide, water and at least one ionic compound.

### Apparatus

In one embodiment, disclosed herein is an absorption cycle system apparatus comprising an absorber, a generator, a condenser, an expansion device, and an evaporator, wherein the working fluid contained within the apparatus comprises lithium bromide, water and at least one ionic compound.

In one embodiment, the disclosed apparatus is similar in arrangement to that shown in FIG. 1. In one embodiment, the disclosed apparatus further comprises a heat exchanger.

In another embodiment, disclosed herein is an absorption cycle apparatus comprising an absorber, a generator, a condenser, an expansion device, and an evaporator; wherein the working fluid contained within the apparatus comprises lithium bromide, water and at least one ionic compound; and wherein the apparatus is an absorption chiller

In another embodiment, disclosed herein is an absorption cycle apparatus comprising an absorber, a generator, a condenser, an expansion device, and an evaporator; wherein the working fluid contained within the apparatus comprises lithium bromide, water and at least one ionic compound; and wherein the apparatus is an absorption heat pump.

This invention relates to a temperature adjustment device that is based on the use of a refrigerant pair in an absorption cooling and/or heating system, and which thus executes an absorption cycle. This invention also relates to materials to be included in a useful refrigerant pair, and also to a method for temperature adjustment, either cooling or heating, as is obtained by the operation of a temperature adjustment device utilizing refrigerant pairs as described herein. This invention also relates to methods for improving refrigerant pairs suitable for use herein by incorporating those refrigerant pairs into working fluids having advantageous properties.

A refrigerant is a fluidic substance that may be used as a thermal energy transfer vehicle. A refrigerant, when it changes phase from liquid to vapor (evaporates), removes heat from the surroundings; and when it changes phase from vapor to liquid (condenses), adds heat to the surroundings. Although the term refrigerant may carry the connotation of a substance used only for cooling, the term is used herein in the generic sense of a thermal energy transfer vehicle or substance that is applicable for use in a system or device that may be used for cooling and/or heating.

The terms “refrigerant pair” and “refrigerant/absorbent pair” are used interchangeably, and refer to a mixture suitable for use in the execution or operation of an absorption cycle, which requires the presence of both a refrigerant and an absorbent, where the absorbent absorbs the refrigerant. The energy efficiency of the absorption cycle will increase in direct proportion to the extent to which the absorbent has high absorption for the refrigerant (i.e. the refrigerant has high miscibility therewith or the refrigerant is soluble therein to a large extent). An absorbent as used in an absorption heating or cooling cycle is desirably thus also a material that has high solubility for a refrigerant (e.g. water) and also a very high boiling point relative to the refrigerant. As noted elsewhere, the absorbent herein is typically a lithium halide, or an aqueous lithium halide solution, and the refrigerant is typically water.

A working fluid is a composition of a refrigerant pair and one or more additives that are incorporated therein to improve the efficiency with which the refrigerant pair transfers thermal energy as the absorption cycle is executed within a temperature adjustment device.

A schematic diagram for a typical absorption cycle, and the components contained in a device by which it may be run, is shown in FIG. 1. The device is composed of condenser and evaporator units with an expansion valve similar to an ordinary vapor compression cycle, but an absorber-generator solution circuit replaces the compressor. The circuit may be composed of an absorber, a generator, a heat exchanger, a pressure control device and a pump for circulating the solution. In some embodiments, the heat released by the absorber upon the absorption of the refrigerant by the absorbent may be used to heat a mixture of refrigerant and absorbent in the generator to separate the refrigerant in vapor form from the absorbent.

As shown in FIG. 1, a typical device for operating an absorption cycle may include components such as an absorber-generator solution circuit as shown on the left side of the drawing, which by the outflow and inflow of heat increases the pressure of refrigerant vapor as a compressor does mechanically, where the circuit may be composed of an absorber, a generator, a heat exchanger, a pressure control device and a pump for circulating the solution. The apparatus also is composed of condenser and evaporator units with an expansion valve, as shown on the right side of the drawing.

In the apparatus as shown in FIG. 1, mixture of a refrigerant and an absorbent is formed in the absorber; the mixture is passed to a generator where the mixture is heated to separate refrigerant, in vapor form, from the absorbent, and the pressure of the refrigerant vapor is increased; the refrigerant vapor is passed to a condenser where the vapor is condensed under pressure to a liquid; the liquid refrigerant is passed to an expansion device where the pressure of the liquid refrigerant is reduced to form a mixture of liquid and vapor refrigerant; the mixture of liquid and vapor refrigerant is passed to an evaporator where the remaining liquid is evaporated to form refrigerant vapor; the refrigerant vapor leaving the evaporator is passed to the absorber to repeat step (a) and re-form a mixture of the refrigerant vapor and the absorbent.

An absorption cycle, and systems in which it may be run, are discussed further in Application Guide for Absorption Cooling/Refrigeration Using Recovered Heat [Dorgan et al (American Society of Heating, Refrigeration and Air Conditioning Engineers, Inc., 1995, Atlanta Ga., Chapter 5)], and in Van Nostrand's Scientific Encyclopedia, “Heat Pump”, 2005, John Wiley & Sons, Inc.

A device as shown in FIG. 1, and the devcie as disclosed herein, is capable of executing an absorption cycle using a lithium halide as the absorbent and water as the refrigerant. Such a device is also capable of executing any one or more of the methods as described herein. Yet another embodiment of this invention is thus a device substantially as shown or described in FIG. 1.

In one embodiment, this invention thus provides a device for heating an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser, located in proximity to the object, medium or space to be heated, that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator that receives the mixture of liquid and vapor refrigerant that passes through the pressure reduction device to evaporate the remaining liquid to form refrigerant vapor; and (f) means to pass the refrigerant vapor leaving the evaporator to the absorber.

In another embodiment, this invention also provides a device for cooling an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator, located in proximity to the object, medium or space to be cooled, that receives the mixture of liquid and vapor refrigerant that passes through the pressure reduction device to evaporate the remaining liquid to form refrigerant vapor; and (f) means to pass the refrigerant vapor leaving the evaporator to the absorber.

A device of this invention may be deployed for use in, or fabricated or operated as, a refrigerator, a freezer, an ice machine, an air conditioner, an industrial cooling system, a heater or heat pump. Each of these instruments may be situated in a residential, commercial or industrial setting, or may be incorporated into a mobilized device such as a car, truck, bus, train, airplane, or other device for transportation, or may be incorporated into a piece of equipment such as a medical instrument.

In another embodiment, this invention also provides a method for heating an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid in proximity to the object, medium or space to be heated; (d) reducing the pressure of the liquid refrigerant, and evaporating the refrigerant to form refrigerant vapor; and (e) repeating step (a) to re-absorb, with the absorbent, the refrigerant vapor.

In another embodiment, this invention also provides a method for cooling an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid; (d) reducing the pressure of the liquid refrigerant, and evaporating the refrigerant, in proximity to the object, medium or space to be cooled, to form refrigerant vapor; and (e) repeating step (a) to re-absorb, with the absorbent, the refrigerant vapor.

In another embodiment, this invention also provides a method for heating an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser in proximity to the object, medium or space to be heated where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator where the remaining liquid is evaporated to form refrigerant vapor; and (f) passing the refrigerant vapor leaving the evaporator to the absorber to repeat step (a) and re-form a mixture of the refrigerant vapor and the absorbent.

In another embodiment, this invention also provides a method for cooling an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator in proximity to the object, medium or space to be cooled where the remaining liquid is evaporated to form refrigerant vapor; and (f) passing the refrigerant vapor leaving the evaporator to the absorber to repeat step (a) and re-form a mixture of the refrigerant vapor and the absorbent.

In any device or method as described above, the absorbent, refrigerant and/or working fluid may be any one or more of those described herein, and the absorbent separated from refrigerant in step (b) may be recirculated for use in a later step.

Other related absorption temperature adjustment systems, and methods for using same, are disclosed in the concurrently-filed, commonly-assigned application listed as follows by attorney docket number and U.S. Provisional filing number, which is by this reference incorporated in its entirety as a part hereof for all purposes, to-with:

CL4624, U.S. Provisional Application No. 61/165,155 (now U.S. Application Ser. No. 12/______).

### EXAMPLES

The concepts disclosed herein will be further described in the following examples, which do not limit the scope of the invention described in the claims.

### General Methods And Materials

Ionic compounds as used in the below examples are commercially available from the following sources, or may be prepared as described in the following:

| Ionic compound | Source |
|---|---|
| N,N-dimethylethanolammonium acetate | Bioniqs, York, UK |
| bis(2-methoxyethyl)ammonium acetate | |
| N,N-dimethylethanolammonium glycolate | |
| N,N-dimethylethanolammonium propanoate | |
| diethanolammonium trifluoroacetate | |
| tris-(2-hydroxyethyl)-methylammonium | Fluka Chemicals, |
| methylsulfate | Milwaukee, WI, USA |
| 1-butyl-3-methylimidazolium acetate | |
| 1-ethyl-3-methylimidazolium acetate | |
| 1,2,4-trimethylpyrazolium methylsulfate | |
| 1-butyl-3-methylimidazolium methylsulfate | Solvent Innovation, |
| | Cologne, Germany |
| 1-butyl-1-methylpyrrolidinium | EMD Chemicals Inc., |
| trifluoroacetate | Gibbstown, NJ, USA |
| 1-butyl-3-methylimidazolium trifluoroacetate | |
| 1-ethyl-3-methylimidazolium trifluoroacetate | |
| N,N-dimethylethanolammonium acetate | |
| methyltrioctylammonium trifluoroacetate | |
| lithium acetate dihydrate | Aldrich, St, Louis, MO, |
| | USA |
| choline levulinate | see Preparation 1 below |
| tetramethylammonium formate | see Preparation 2 below |
| choline glycolate | see Preparation 3 below |
| 1-butyl-3-methylimidazolium dihydrogen | see Preparation 4 below |
| phosphite | |
| 1-ethyl-3-methylimidazolium dihydrogen | see Preparation 4 below |
| phosphite | |
| 1-butyl-3-methylimidazolium levulinate | see Preparation 5 below |
| 1-ethyl-3-methylimidazolium levulinate | see Preparation 5 below |
| 1-butyl-3-methylimidazolium isobutyrate | see Preparation 6 below |
| 1-butyl-3-methylimidazolium propanoate | see Preparation 7 below |
| Tetramethylammonium pyruvate | see Preparation 8 below |
| sodium glycolate | see Preparation 9 below |
| tetramethylammonium dichloroacetate | see Preparation 10 below |
| tetrabutylphosphonium succinamate | see Preparation 11 below |
| 1-butyl-3-methylimidazolium 1,1,2-trifluoro- | see Preparation 12 below |
| 2-(perfluoroethoxy)ethanesulfonate | |
| [bmim][TPES] | |
| 1-(N,N,N-dimethylpropylaminoethyl)-5- | see Preparation 13 below |
| methylpyrrolidine-2-one levulinate | |
| [MeDMPAP][Lev] | |
| 1-butyl-3-methylimidazolium 1,1,2,3,3,3- | see Preparation 14 below |
| hexafluoropropanesulfonate | |
| [bmim][HFPS] | |
| choline 1,1,2,2-tetrafluoroethanesulfonate | see Preparation 15 below |
| [choline][TFES] | |
| Tetradecyl(tri-n-butyl)phosphonium | See Preparation 16 below |
| 1,1,2,3,3,3-hexafluoropropanesulfonate | |
| [4,4,4,14]P[HFPS] | |
| 1-butyl-2,3-dimethylimidazolium 1,1,2,2- | See Preparation 17 below |
| tetrafluoroethanesulfonate | |
| [b2mim][TFES] | |
| Tetradecyl(tri-n-butyl)phosphonium 1,1,2,2- | See Preparation 18 below |
| tetrafluoroethanesulfonate | |
| [4,4,4,14]P[TFES] | |
| 1-butyl-3-methylimidazolium 1,1,2-trifluoro- | See Preparation 19 below |
| 2-(trifluoromethoxy)ethanesulfonate | |
| [bmim][TTES] | |
| tetrabutylphosphonium 1,1,2-trifluoro-2- | See Preparation 20 below |
| (trifluoromethoxy)ethanesulfonate | |
| [TBP][TTES] | |
| 1-ethyl-3-methylimidazolium ascorbate | See Preparation 21 below |
| [emim][ascorbate] | |
| 1,3-dimethylimidazolium 1,1,2-trifluoro-2- | See Preparation 22 below |
| (perfluoroethoxy)ethanesulfonate | |
| [mimm][TPES] | |
| tetramethylammonium tropolonate | See Preparation 23 below |
| [TMA][tropolonate] | |
| Tetramethylammonium levulinate | See Preparation 24 below |
| [TMA][Lev] | |
| 1-ethyl-3-methylimidazolium 1,1,2,2- | See Preparation 25 below |
| tetrafluoroethanesulfonate | |
| [emim][TFES] | |
| Trimethylbenzylammonium | See Preparation 26 below |
| phosphonoacetate | |
| [N111benz][phosphonoacetate] | |
| 1,3-dimethylimidazolium levulinate | See Preparation 27 below |
| [mmim][Lev] | |
| 1-butyl-3-methylimidazolium 1,1,2,2- | See Preparation 28 below |
| tetrafluoroethanesulfonate | |
| 1-octyl-3-methylimidazolium 1,1,2,2- | See preparation 29 below |
| tetrafluoroethanesulfonate [omim] [TFES] | |
| Tetradecyl(trihexyl)phosphonium | See preparation 31 below |
| nonafluorobutanesulfonate | |
| 1,3-dimethylimidazolium iodide | See preparation 32 below |

### Preparation 1—Choline Levulinate

To a 125-mL Erlenmeyer flask, equipped with a magnetic stir bar, in a nitrogen atmosphere glove box, was added 13.46 grams of choline hydroxide solution (45 wt % in methanol, Aldrich, St. Louis, Mo., USA). To a scintillation vial was weighed 6.22 grams of levulinic acid (98%, Aldrich, 0.052 mole). To slightly dilute the levulinic acid, about 5 mL of methanol was added. The solution of levulinic acid and methanol was then added to the stirred solution of choline hydroxide in methanol. The scintillation vial was rinsed with three 1.5-mL portions of methanol into the Erlenmeyer flask to complete the addition. The reaction mixture was allowed to stir at ambient temperature overnight.

About 3.25 grams of activated decolorizing carbon was then added to the reaction mixture. The product liquid was filtered from the activated carbon through a thin pad of filter aid (a diatomaceous earth filtering medium sold under the trademark Celite® from World Minerals, Santa Barbara, Calif.) wetted with methanol in a plastic fitted filter funnel. The Erlenmeyer flask and filtered solids were rinsed with the same three 10 mL portions of methanol collected with the filtrate. The resulting yellow product filtrate was transferred to a 200-mL round bottom flask, equipped with a magnetic stirbar, and the volatile materials were removed using a high-vacuum pump with a liquid N₂ trap fitted for the glovebox. Further removal of residual volatile materials was performed under vacuum in the glovebox antechamber (<30 mTorr) to afford 10.19 grams of a clear yellow liquid.

### Preparation 2—Tetramethylammonium Formate [TMA] [Formate]

Tetramethylammonium hydroxide (16.25 grams of 25% in methanol, Aldrich) was treated with formic acid (2.2658 g of 90.4%, Mallinckrodt Baker, Phillipsburg, N.J., USA) at room temperature with stirring until completely homogeneous. Solvent was removed under reduced pressure, and the product obtained was a white solid.

### Preparation 3—Choline Glycolate

In a nitrogen atmosphere glovebox, 269.3 grams of choline hydroxide solution (45 wt % in methanol, Aldrich) was added into a 500-mL Erlenmeyer flask. The choline hydroxide solution was poured into a 500-mL round bottom flask, equipped with a magnetic stirbar. The 500-mL Erlenmeyer flask was rinsed with three 10-mL portions of methanol into the 500-mL round bottom flask to complete the transfer. To a 250-mL Erlenmeyer flask was weighed 76.8 g of glycolic acid (99%, Aldrich). The glycolic acid was slowly added over 20 min to the stirred solution of choline hydroxide in methanol. The 250-mL Erlenmeyer flask was rinsed with three 10-mL portions of methanol into the 500-mL round bottom flask to complete the addition. After 3 hours following the addition of glycolic acid to the choline hydroxide solution, three 20-mL portions of activated decolorizing carbon were added to the reaction mixture. The reaction mixture was allowed to stir overnight at ambient temperature.

The resulting reaction mixture was filtered through successive pads of activated decolorizing carbon (pre-wetted with methanol) on top of a pad of filter aid (a diatomaceous earth filtering medium sold under the trademark Celite® from World Minerals, Santa Barbara, Calif.) (also pre-wetted with methanol) in a 500-mL plastic fritted filter funnel. The filter pad of solids was rinsed with three 20-mL portions of methanol collected with the filtrate. The resulting yellow product filtrate was transferred to a clean 500-mL round bottom flask, equipped with a magnetic stirbar. The volatile materials were removed using a high-vacuum pump with a liquid N₂ trap fitted for the glovebox. The residual volatile materials were then removed under vacuum at ambient temperature in a glovebox antechamber (<100 mTorr) to afford 166.6 grams of a viscous yellow liquid product.

### Preparation 4—bmim and emim dihydrogen phosphites

1-Butyl-3-methylimidazolium (bmim) bicarbonate (1.0230 grams of 50% in H₂O, Aldrich) was treated with phosphorous acid (0.2090 grams of 99%, Aldrich) at room temperature with stirring. Rapid gas evolution was observed, and the mixture was stirred until completely homogeneous. Water was removed under reduced pressure, and the product obtained was a clear, viscous oil. 1-Ethyl-3-methylimidazolium (emim) bicarbonate (1.0162 grams of 50% in MeOH/H₂O, Aldrich) was treated with phosphorous acid (0.2387 grams of 99%, Aldrich) at room temperature with stirring. Rapid gas evolution was observed, and the mixture was stirred until completely homogeneous. Solvent was removed under reduced pressure, and the product obtained was a clear, viscous oil.

### Preparation 5

1-Butyl-3-methylimidazolium levulinate ([bmim)[Lev]), with a structure as shown, was prepared as set forth below:

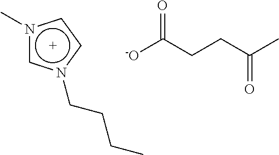

Water (300 mL) and silver (I) oxide (6.0 grams, 0.026 mole) were charged to a 500-mL round bottom flask equipped with a magnetic stirbar. To the stirred dark black slurry, levulinic acid (5.8 grams, 0.050 mole) was added. To the resulting dark brown stirred slurry, 1-butyl-3-methylimidazolium chloride abmim] [Cl], 8.7 grams, 0.050 mole) was then added. Upon addition of the ([bmim] [Cl], the formation of a white precipitate (presumably AgCl) was evident. The reaction mixture was allowed to stir at ambient temperature for 16 hours, after which time the mixture appeared to be a tinted white slurry.

The resulting reaction mixture was filtered through a pad of filter aid filter aid (a diatomaceous earth filtering medium sold under the trademark Celite® from World Minerals, Santa Barbara, Calif.), pre-wetted with water, on top of a fitted glass filter, and the filtrate containing the desired product was collected. The residual product in the pad of filter aid was rinsed from the filter aid with an additional three 30-mL portions of water and collected with the filtrate. The bulk of the water solvent was removed from the filtrate under vacuum with a rotary evaporator. The product was then further dried with a high-vacuum pump, leaving 10.6 grams of product.

1-Ethyl-3-methylimidazolium levulinate ([emim)[Lev]), with a structure as shown, was prepared as set forth below:

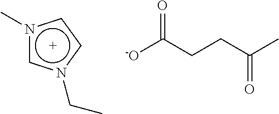

Water (300 mL) and silver (I) oxide (6.0 grams, 0.026 mole) were charged to a 500-mL round bottom flask equipped with a magnetic stirbar. To the stirred dark black slurry, levulinic acid (6.0 grams, 0.052 mole) was added. To the resulting dark brown stirred slurry, 1-ethyl-3-methylimidazolium chloride ([emim] [Cl]), 7.6 grams, 0.052 mole) was then added. Upon addition of the [emim] [Cl], the formation of a white precipitate (believed to be AgCl) was evident. The reaction mixture was allowed to stir at ambient temperature for 16 hours, after which time the mixture appeared to be a tinted white slurry.

The resulting reaction mixture was filtered through a pad of filter [aid (a diatomaceous earth filtering medium sold under the trademark Celite® from World Minerals, Santa Barbara, Calif.), pre-wetted with water, on top of a fritted glass filter, and the filtrate containing the desired product was collected. The residual product in the pad of filter aid was rinsed from the filter aid with an additional three 30-mL portions of water and collected with the filtrate. The bulk of the water solvent was removed from the filtrate under vacuum with a rotary evaporator. The product was then further dried with a high-vacuum pump, leaving 8.3 grams of product.

### Preparation 6—1-Butyl-3-methylimidazolium isobutyrate [bmim-isobutyrate]

To a 500-mL round bottom flask, equipped with a magnetic stirbar, was added 6.46 grams of silver(I) oxide (Ag₂O, Aldrich, 0.028 mole) and about 35 mL of CH₃NO₂ solvent. The flask was placed in an ice-water bath on a magnetic stirplate. To the stirred slurry of Ag₂O was slowly added 3.96 grams of isobutyric anhydride (Aldrich, 0.025 mole) dissolved in about 40 mL of CH₃NO₂ solvent. The resulting stirred slurry was allowed to warm to ambient temperature, and to this mixture was slowly added 8.68 grams of 1-butyl-3-methylimidazolium chloride (bmim-Cl, Fluka/Aldrich, 0.050 mole) dissolved in about 30 mL of CH₃NO₂ solvent. The color of the slurried solids appeared to change from black to yellow in about the first 10 min after addition of the bmim-Cl. The resulting reaction mixture was allowed to stir for about 48 hours.

The product mixture was filtered, and volatile materials were removed from the filtrate under vacuum with a rotary evaporator at 50° C. Further removal of volatile materials under vacuum was done in a glovebox antechamber (<100 mTorr) at ambient temperature for about 16 hours to give 11 grams of an intermediate orange product liquid, which became slightly cloudy with additional precipitate.

To an 8.1 gram portion of the cloudy intermediate product liquid was added about 250 mL of water. The resulting aqueous solution of product was filtered through filter aid (a diatomaceous earth filtering medium sold under the trademark Celite® from World Minerals, Santa Barbara, Calif.). The majority of the water was removed from the product filtrate using a rotary evaporator at 50° C. The residual volatile materials were then removed under vacuum at ambient temperature in a glovebox antechamber (<100 mTorr) for about 16 hours to afford 6.3 g of a clear orange liquid.

### Preparation 7—1-Butyl-3-methylimidazolium propanoate [bmim-propanoate]

To a 500-mL round bottom flask, equipped with a magnetic stirbar, was added 6.46 grams of silver(I) oxide (Ag₂O, Aldrich, 0.028 mole) and about 40 mL of CH₃NO₂ solvent. The flask was placed in an ice-water bath on a magnetic stirplate. To the stirred slurry of Ag₂O was slowly added 3.25 grams of propionic anhydride (Aldrich, 0.025 mole) dissolved in about 40 mL of CH₃NO₂ solvent. The resulting stirred slurry was allowed to warm to ambient temperature, and to this mixture was added 8.70 grams of 1-butyl-3-methylimidazolium chloride (bmim-Cl, Fluka/Aldrich, 0.050 mole) dissolved in about 40 mL of CH₃NO₂ solvent. The resulting reaction mixture was allowed to stir for about 16 hours. The color of the slurried solids appeared to change from black to yellow.

The product mixture was filtered, and volatile materials were removed from the filtrate under vacuum with a rotary evaporator at 50° C. To this intermediate product liquid, which became cloudy with additional precipitate, was added about 250 mL of water. The resulting aqueous solution of product was filtered through filter aid (a diatomaceous earth filtering medium sold under the trademark Celite® from World Minerals, Santa Barbara, Calif.).

The majority of the water was removed from the product filtrate using a rotary evaporator at 50° C. The residual volatile materials were then removed under vacuum at ambient temperature in a glovebox antechamber (<100 mTorr) for about 16 hours to afford 9.3 grams of a clear red liquid.

### Preparation 8—Tetramethylammonium pyruvate

Tetramethylammonium hydroxide (16.25 grams of 25% in methanol, Aldrich) is treated with pyruvic acid (2.3 g of 95%, Aldrich) at room temperature with stirring until completely homogeneous. Solvent is removed under reduced pressure, and the product obtained is a white solid.

### Preparation 9—Sodium glycolate

In a nitrogen atmosphere glovebox, 2.84 grams of sodium methoxide (95%, Aldrich, 0.050 mol) was added into a 50-mL round bottom flask equipped with a magnetic stirbar. To a scintillation vial was weighed 3.84 grams of glycolic acid (99%, Aldrich, 0.050 mole). About 10 mL of methanol was added to the scintillation vial, which dissolved most of the glycolic acid. The methanol solution of glycolic acid was slowly added dropwise to the 50-mL round bottom flask containing sodium methoxide, with the stirring on. Upon initial addition of the glycolic acid solution, there was a brief period of liquid homogeneity as the residual sodium methoxide dissolved. As the addition of glycolic acid solution continued, a large volume of solids formed relative to the apparent amount of methanol solvent. The scintillation vial was rinsed with three 3-mL portions of methanol to complete the glycolic acid addition to the reaction mixture. Because most of the flask volume (about 90%) appeared to consist of solids, the reaction mixture was allowed to stir for 3 days at ambient temperature to allow for adequate acid-base equilibration.

The volatile materials were then removed from the reaction mixture using a high-vacuum pump with a liquid N₂ trap fitted for the glovebox. The residual volatile materials were removed under vacuum at ambient temperature in a glovebox antechamber (<50 mTorr) to afford 4.3 grams of a white solid.

### Preparation 10—Tetramethylammonium dichloroacetate

Tetramethylammonium hydroxide (16.25 grams of 25% in methanol, Aldrich) is treated with dichloroacetic acid (2.3 grams, Aldrich) at room temperature with stirring until completely homogeneous. Solvent is removed under reduced pressure, and the product obtained is a white solid.

### Preparation 11—Tetrabutylphosphonium succinamate

To a 125-mL round bottom flask, equipped with a magnetic stirbar, was added 34.56 grams of tetrabutylphosphonium hydroxide solution (40 wt % in water, Aldrich, 0.050 mole). To a scintillation vial was weighed 6.04 grams of succinamic acid (97%, Aldrich, 0.050 mole). The solid succinamic acid was carefully added to the stirred solution of tetrabutylphosphonium hydroxide in water. The scintillation vial was rinsed with four 5-mL portions of methanol into the Erlenmeyer flask to complete the addition. The resulting clear reaction solution was allowed to stir at ambient temperature overnight.

The clear reaction solution and stirbar were poured into a 100-mL round bottom flask. The Erlenmeyer flask was rinsed with three 5-mL portions of methanol to complete the transfer. The volatile materials were removed using a high-vacuum pump with a liquid N₂ trap fitted for the glovebox. The residual volatile materials were then removed under vacuum at ambient temperature in a glovebox antechamber (<100 mTorr) to afford 15.81 grams of a solid white product.

### Preparation 12—1-Butyl-3-methylimidazolium 1,1,2-trifluoro-2-(perfluoroethoxy)ethanesulfonate (bmim-TPES)

### Potassium-1,1,2-trifluoro-2-(perfluoroethoxy)ethanesulfonate (TPES-K)

A 1-gallon reaction vessel (made of a nickel alloy sold under the trademark Hastelloy® C276, by Haynes International, Inc., Kokomo, Ind.) was charged with a solution of potassium sulfite hydrate (Aldrich, 88 grams, 0.56 mole), potassium metabisulfite (Mallinckrodt, Phillipsburg, N.J., USA, 340 grams, 1.53 mol) and deionized water (2000 ml). The vessel was cooled to 7° C., evacuated to 0.05 MPa, and purged with nitrogen. The evacuate/purge cycle was repeated two more times. To the vessel was then added perfluoro(ethylvinyl ether) (PEVE, DuPont, Wilmington, Del., USA, 600 grams, 2.78 mole), and it was heated to 125° C. at which time the inside pressure was 2.31 MPa. The reaction temperature was maintained at 125° C. for 10 hours. The pressure dropped to 0.26 MPa at which point the vessel was vented and cooled to 25° C. The crude reaction product was a white crystalline precipitate with a colorless aqueous layer (pH=7) above it.

The product slurry was suction filtered through a fitted glass funnel, and the wet cake was dried in a vacuum oven (60° C., 0.01 MPa) for 48 hours. The product was obtained as off-white crystals (904 g, 97% yield).

### 1-Butyl-3-methylimidazolium 1,1,2-trifluoro(perfluoroethoxy)ethanesulfonate

1-Butyl-3-methylimidazolium chloride (bmim-Cl, Acros, Hampton, N.H., USA, 7.8 grams) and dry acetone (150 mL) were combined at room temperature in a 500 ml flask. At room temperature in a separate 200 ml flask, potassium 1,1,2-trifluoro-2-(perfluoroethoxy)ethanesulfonate (TPES-K, 15.0 grams) was dissolved in dry acetone (300 mL). These two solutions were combined and allowed to stir magnetically for 12 hours under positive nitrogen pressure. The KCl precipitate was then allowed to settle leaving a colorless solution above it. The reaction mixture was filtered once through a filter aid pad (a diatomaceous earth filtering medium sold under the trademark Celite® from World Minerals, Santa Barbara, Calif.), wetted with acetone, and again through a fritted glass funnel to remove the KCl. The acetone was removed in vacuo first on a rotovap and then on a high vacuum line (4 Pa, 25° C.) for 2 hours. Residual KCl was still precipitating out of the solution, so methylene chloride (50 ml) was added to the crude product which was then washed with deionized water (2×50 mL). The solution was dried over magnesium sulfate, and the solvent was removed in vacuo to give the product as a viscous light yellow oil (12.0 grams, 62% yield).

### Preparation 13-1—(N N N-dimethylpropylaminoethyl)-5-methylpyrrolidin-2-one levulinate ([MeDMPAP] [Lev])

1-(N,N,N-dimethylpropylaminoethyl)-5-methylpyrrolidone-2-one levulinate ([MeDMPAP] [Lev]), C₁₇H₃₂N₂O₄, with a molecular weight of 328.45 g mol⁻¹ and structure as shown, was prepared as set forth below:

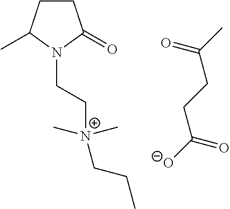

1-(2-(Dimethylamino)ethyl)-5-methylpyrrolidin-2-one (MeDMAP), C₉H₁₈N₂O, with a molecular weight of 170.25 g mol⁻¹ was prepared via the cyclic reductive amination of ethyl levulinate with N,N-dimethylethylenediamine (and as further discussed in U.S. Pat. No. 7,157,588).

To a two-neck 100-mL round bottom flask equipped with a nitrogen-purged reflux condenser was added 18.30 grams (0.108 moles) MeDMAP, 16.66 grams (0.212 moles) 1-chloropropane, and 28.39 grams acetonitrile as reaction solvent. The condenser was cooled by a recirculating bath filled with a 50 wt % mixture of water and propylene glycol maintained at approximately 16° C. The reaction mixture was heated to 85° C. under reflux and nitrogen purge with a temperature-controlled oil bath. This reaction temperature was maintained for 66 hours, at which time the conversion of the MeDMP was about 78% by ¹H NMR spectroscopy. The reaction mixture was then thermally quenched and dried under high vacuum (approximately 10′ torr) using a turbomolecular pump and heating the material to about 70-80° C. overnight.

The intermediate product of this reaction, 1-(N,N,N-dimethylpropylaminoethyl)-5-methylpyrrolidone-2-one chloride ([MeDMPAP] [Cl]), C₁₂H₂₅N₂OCl, with a molecular weight of 248.79 gram mol⁻, was then extracted with multiple diethyl ether extractions (approximately 300 mL in 30-50 mL increments) to remove starting materials, giving a final purity of about 97% [MeDMPAP] [Cl] by ¹H NMR spectroscopy. This chloride salt was dissolved in dichloromethane, stirred with activated carbon overnight, poured through a column packed with neutral and acidic alumina, and then washed with methanol. The final purity of this chloride salt intermediate was approximately 99% by ¹H NMR spectroscopy.

In a 500-mL Erlenmeyer flask, 5.031 grams (0.0202 mole) of this [MeDMPAP] [Cl] intermediate was dissolved in approximately 150 mL of purified water. This solution was added to a slurry of 2.372 grams (0.102 mole) silver(I) oxide and 2.596 grams (0.0224 mole) levulinic acid in approximately 200 mL of purified water. After stirring overnight at room temperature, the reaction mixture was filtered through a fritted funnel containing filter aid (a diatomaceous earth filtering medium sold under the trademark Celite® from World Minerals, Santa Barbara, Calif.) to remove the silver chloride product and residual silver(I) oxide. Water was removed from the filtrate in vacuo with a rotary evaporator, then the product was twice dissolved in methanol, filtered through a fritted funnel containing Celite® to remove residual silver chloride and silver(I) oxide, and then evaporated in vacuo with a rotary evaporator to remove the methanol solvent. The product was then dried under high vacuum (approximately 10⁻⁵ torr) using a turbomolecular pump and heating the material to about 70° C. for two days. The resulting [MeDMPAP] [Lev] product purity was 98.8% by ¹H NMR spectroscopy.

### Preparation 14—1-Butyl-3-methylimidazolium 1,1,2,3,3,3-hexafluoropropanesulfonate

### Potassium 1,1,2,3,3,3-hexafluoropropane sulfonate (HFPS-K)

A 1-gallon reaction vessel (made of a nickel alloy sold under the trademark Hastelloy® C, by Haynes International, Inc., Kokomo, Ind.) is charged with a solution of anhydrous potassium sulfite (25 grams, 0.20 mole), sodium bisulfite 73 grams, (0.70 mole) and of deionized water (400 mL). The pH of this solution is 5.7. The vessel is cooled to 4° C., evacuated to 0.08 MPa, and then charged with hexafluoropropene (HFP, DuPont, 120 grams, 0.8 mole, 0.43 MPa). The vessel is heated with agitation to 120° C. and kept there for 3 hours. The pressure rises to a maximum of 1.83 MPa and then drops down to 0.27 MPa within 30 minutes. At the end, the vessel is cooled and the remaining HFP is vented, and the reactor is purged with nitrogen. The final solution has a pH of 7.3.

The water is removed in vacuo on a rotary evaporator to produce a wet solid. The solid is then placed in a vacuum oven (0.02 MPa, 140° C., 48 hours) to produce a white solid which contains approximately 1 wt % water. The crude HFPS-K can be further purified and isolated by extraction with reagent grade acetone, filtration, and drying.

### 1-Butyl-3-methylimidazolium 1,1,2,3,3,3-hexafluoropropanesulfonate

1-Butyl-3-methylimidazolium chloride (bmim-Cl, 50.0 grams, Acros, Hampton, N.H.) and high purity dry acetone (>99.5%, 500 mL) were combined in a 1 liter flask and warmed to reflux with magnetic stirring until the solid all dissolved. At room temperature in a separate 1 liter flask, potassium-1,1,2,3,3,3-hexafluoropropanesulfonte (HFPS-K) was dissolved in high purity dry acetone (550 mL). These two solutions were combined at room temperature and allowed to stir magnetically for 12 hours under positive nitrogen pressure. The stirring was stopped, and the KCl precipitate was allowed to settle. This solid was removed by suction filtration through a fritted glass funnel with a filter aid pad filter aid (a diatomaceous earth filtering medium sold under the trademark Celite® from World Minerals, Santa Barbara, Calif.). The acetone was removed in vacuo to give a yellow oil. The oil was further purified by diluting with high purity acetone (100 mL) and stirring with decolorizing carbon (5 grams). The mixture was suction filtered and the acetone removed in vacuo to give a colorless oil. This was further dried at 4 Pa and 25° C. for 2 hr to provide 68.6 grams of product.

### Preparation 15—Choline 1,1,2,2-tetrafluoroethanesulfonate (TFES-K) ([HCF₂CF₂SO₃]⁻)

### Potassium 1,1,2,2-tetrafluoroethanesulfonate

A 1-gallon reaction vessel (made of a nickel alloy sold under the trademark Hastelloy® C276, by Haynes International, Inc., Kokomo, Ind.) was charged with a solution of potassium sulfite hydrate (176 grams, 1.0 mole), potassium metabisulfite (610 grams, 2.8 mole) and deionized water (2000 mL). The pH of this solution was 5.8. The vessel was cooled to 18° C., evacuated to 0.10 MPa, and purged with nitrogen. The evacuate/purge cycle was repeated two more times. To the vessel was then added tetrafluoroethylene (TFE, 66 grams), and it was heated to 100° C. at which time the inside pressure was 1.14 MPa. The reaction temperature was increased to 125° C. and kept there for 3 hours. As the TFE pressure decreased due to the reaction, more TFE was added in small aliquots (20-30 grams each) to maintain operating pressure roughly between 1.14 and 1.48 MPa. Once 500 grams (5.0 mol) of TFE had been fed after the initial 66 grams precharge, the vessel was vented and cooled to 25° C. The pH of the clear light yellow reaction solution was 10-11. This solution was buffered to pH 7 through the addition of potassium metabisulfite (16 grams).

The water was removed in vacuo on a rotary evaporator to produce a wet solid. The solid was then placed in a freeze dryer (Virtis Freezemobile 35×1; Gardiner, N.Y.) for 72 hours to reduce the water content to approximately 1.5 wt % (1387 grams crude material). The theoretical mass of total solids was 1351 grams. The mass balance was very close to ideal and the isolated solid had slightly higher mass due to moisture. This added freeze drying step had the advantage of producing a free-flowing white powder whereas treatment in a vacuum oven resulted in a soapy solid cake that was very difficult to remove and had to be chipped and broken out of the flask.

The crude TFES-K can be further purified and isolated by extraction with reagent grade acetone, filtration, and drying.

### 1,1,2,2-tetrafluoroethanesulfonic acid

A 100 mL round bottom flask with a sidearm is equipped with a digital thermometer and a magnetic stirbar and placed in an ice bath under positive nitrogen pressure. To the flask is added 50 grams crude TFES-K from the previous step along with 30 grams of concentrated sulfuric acid (EM Science, 95-98%) and 78 grams oleum (Acros, 20 wt % SO₃) while stirring. This amount of oleum is chosen so that the SO₃ reacts with and removes the water in the sulfuric acid as well as in the crude TFES-K while still being present in slight excess. The mixing causes a small exotherm which is controlled by the ice bath. Once the exotherm is over, a distillation head with a water condenser is placed on the flask and it is heated under nitrogen behind a safety shield. The pressure is slowly reduced using a PTFE membrane vacuum pump (Buchi V-500) in steps of 100 Torr (13 kPa) in order to avoid foaming. A dry-ice trap is also placed between the distillation apparatus and the pump to collect any excess SO₃. Once the pot temperature reaches 120° C. and the pressure is held at 20-30 Torr (2.7-4.0 kPa) a colorless liquid starts to reflux and later distills at 110° C. and 31 Torr (4.1 kPa). A forerun of lower-boiling impurity (2.0 grams) is obtained before collecting 28 grams of the desired colorless acid, TFESA.

### Choline 1,1,2,2-tetrafluoroethanesulfonate

In a nitrogen atmosphere glovebox, about 100 grams of choline hydroxide solution (45 wt % in methanol, Aldrich) is added into a 500-mL Erlenmeyer flask. The choline hydroxide solution is poured into a 500-mL round bottom flask, equipped with a magnetic stirbar. The 500-mL Erlenmeyer flask is rinsed with three 10-mL portions of methanol into the 500-mL round bottom flask to complete the transfer. To a 250-mL Erlenmeyer flask is weighed about 25 grams of TFESA. The TFESA was slowly added over 20 minutes to the stirred solution of choline hydroxide in methanol. The 250-mL Erlenmeyer flask was rinsed with three 10-mL portions of methanol into the 500-mL round bottom flask to complete the addition. After 3 hours following the addition of TFESA to the choline hydroxide solution, three 10-mL portions of activated decolorizing carbon were added to the reaction mixture. The reaction mixture was allowed to stir overnight at ambient temperature.

The product liquid was filtered from the activated carbon through a thin pad filter aid (a diatomaceous earth filtering medium sold under the trademark Celite® from World Minerals, Santa Barbara, Calif.), wetted with methanol, in a plastic fritted filter funnel. The Erlenmeyer flask and filtered solids were rinsed with the same three 10 mL portions of methanol collected with the filtrate. The resulting product filtrate was transferred to a 200-mL round bottom flask, equipped with a magnetic stirbar, and the volatile materials were removed using a high-vacuum pump with a liquid N₂ trap fitted for the glovebox. Further removal of residual volatile materials was performed under vacuum in the glovebox antechamber (<30 mTorr) to afford a clear liquid.

### Preparation 16—Tetradecyl(tri-n-butyl)phosphonium 1,1,2,3,3,3-hexafluoropropanesulfonate [4,4,4,14]P[HFPS]

To a 4 liter round bottom flask was added tetradecyl(tri-n-butyl)phosphonium chloride (an ionic liquid sold under the trademark Cyphos® IC167, Cytec Industries, Inc., West Paterson, N.J., 345 grams) and deionized water (1000 mL). The mixture was magnetically stirred until it was one phase. In a separate 2 liter flask, potassium 1,1,2,3,3,3-hexafluoropropanesulfonate (HFPS-K, 214 grams, see Preparation 14) was dissolved in deionized water (1100 mL). These solutions were combined producing a milky white oil. The oil slowly solidified (439 grams) and was removed by suction filtration and then dissolved in chloroform (300 mL). The remaining aqueous layer (pH=2) was extracted once with chloroform (100 mL). The chloroform layers were combined and washed with an aqueous sodium carbonate solution (50 mL) to remove any acidic impurity. They were then dried over magnesium sulfate, suction filtered, and reduced in vacuo first on a rotovap and then on a high vacuum line (4 Pa, 100° C.) for 16 hours to yield the final product that solidifies to a white solid on cooling to room temperature (380 grams, 76% yield).

### Preparation 17—1-Butyl-2,3-dimethylimidazolium 1,1,2,2-tetrafluoroethanesulfonate [b2mim] [TFES]

1-Butyl-2,3-dimethylimidazolium chloride (22.8 g, 0.121 moles, Acros, Hampton, N.H., USA) was mixed with reagent-grade acetone (250 ml) in a large round-bottomed flask and stirred vigorously. Potassium 1,1,2,2-tetrafluoroethanesulfonate (TFES-K, 26.6 grams, 0.121 moles, see Preparation 15), was added to reagent grade acetone (250 mL) in a separate round-bottomed flask, and this solution was carefully added to the 1-butyl-2,3-dimethylimidazolium chloride solution. The large flask was lowered into an oil bath and heated at 60° C. under reflux for 10 hours. The reaction mixture was then filtered using a large frit glass funnel to remove the white KCl precipitate formed, and the filtrate was placed on a rotary evaporator for 4 hours to remove the acetone. The reaction scheme is shown below:

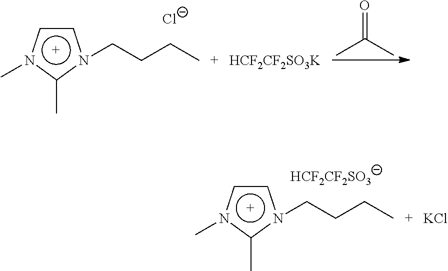

### Preparation 18—Tetradecyl(tri-n-butyl)phosphonium 1,1,2,2-tetrafluoroethanesulfonate [4,4,4,14]P[TFES]

To a 4 liter round bottom flask is added Ltetradecyl(tri-n-butyl)phosphonium chloride (an ionic liquid sold under the trademark Cyphos® IL 167, Cytec Industries, Inc., West Paterson, N.J.), ˜340 grams) and deionized water (1000 mL). The mixture is magnetically stirred until it is one phase. In a separate 2 liter flask, potassium 1,1,2,2-tetrafluoroethanesulfonate (TFES-K, ˜210 grams, see Preparation 15) is dissolved in deionized water (1100 mL). These solutions are combined producing a milky, white oil. The oil slowly solidifies (˜400 grams) and is removed by suction filtration and then dissolves in chloroform (300 mL). The remaining aqueous layer (pH=2) is extracted once with chloroform (100 mL). The chloroform layers are combined and washed with an aqueous sodium carbonate solution (50 mL) to remove any acidic impurity. They are then dried over magnesium sulfate, suction filtered, and reduced in vacuo first on a rotovap and then on a high vacuum line (4 Pa, 100° C.) for ˜16 hours to yield the final product that solidifies to a white solid on cooling to room temperature (−70% yield).

### Preparation 19—1-Butyl-3-methylimidazolium 1,1,2-trifluoro-2-(trifluoromethoxy)ethanesulfonate (bmim-TTES) potassium-1,1,2-trifluoro-2-(trifluoromethoxy)ethanesulfonate (TTES-K)

A 1-gallon reaction vessel (made of a nickel alloy sold under the trademark Hastelloy® C276, by Haynes International, Inc., Kokomo, Ind.) was charged with a solution of potassium sulfite hydrate (114 grams, 0.72 mol), potassium metabisulfite (440 grams, 1.98 mol) and deionized water (2000 mL). The pH of this solution was 5.8. The vessel was cooled to −35° C., evacuated to 0.08 MPa, and purged with nitrogen. The evacuate/purge cycle was repeated two more times. To the vessel was then added perfluoro(methylvinyl ether) (PMVE, 600 grams, 3.61 mol) and it was heated to 125° C. at which time the inside pressure was 3.29 MPa. The reaction temperature was maintained at 125° C. for 6 hours. The pressure dropped to 0.27 MPa at which point the vessel was vented and cooled to 25° C. Once cooled, a white crystalline precipitate of the desired product formed leaving a colorless clear aqueous solution above it (pH=7).

The ¹⁹F NMR spectrum of the white solid showed pure desired product, while the spectrum of the aqueous layer showed a small but detectable amount of a fluorinated impurity.

The solution was suction filtered through a fritted glass funnel for 6 hr to remove most of the water. The wet cake was then dried in a vacuum oven at 0.01 MPa and 50° C. for 48 hours. This gave 854 grams (83% yield) of a white powder. The final product was isomerically pure (by ¹⁹F and ¹H NMR) since the undesired isomer remained in the water during filtration.

### 1-Butyl-3-methylimidazolium-1,1,2-trifluoro-2-(trifluoromethoxy)ethanesulfonate

1-Butyl-3-methylimidazolium chloride (bmim-Cl, 10.0 grams, Aldrich) and deionized water (15 mL) were combined at room temperature in a 200 ml flask. At room temperature in a separate 200 ml flask, potassium 1,1,2-trifluoro-2-(trifluoromethoxy)ethanesulfonate (TTES-K, 16.4 grams) was dissolved in deionized water (90 mL). These two solutions were combined at room temperature and allowed to stir magnetically for 30 minutes under positive nitrogen pressure to give a biphasic mixture with the desired ionic liquid as the bottom phase. The layers were separated, and the aqueous phase was extracted with 2×50 ml portions of methylene chloride. The combined organic layers were dried over magnesium sulfate and concentrated in vacuo. The colorless oil product was dried at for 4 hours at 5 Pa and 25° C. to afford 15.0 grams of product.

### Preparation 20—Tetrabutylphosphonium 1,1,2-trifluoro-2-(trifluoromethoxy)ethanesulfonate [TBP] [TTES]

To a 200 mL round bottomed flask was added deionized water (100 mL) and tetra-n-butylphosphonium bromide (Cytec Canada Inc., 20.2 grams). The mixture was magnetically stirred until the solid all dissolved. In a separate 300 mL flask, potassium 1,1,2-trifluoro-2-(perfluoroethyoxy)ethanesulfonate (TTES-K, 20.0 grams, see Preparation 19) was dissolved in deionized water (400 mL) heated to 70° C. These solutions were combined and stirred under positive N₂ pressure at 26° C. for 2 hours producing a lower oily layer. The product oil layer was separated and diluted with chloroform (30 mL), then washed once with an aqueous sodium carbonate solution (4 mL) to remove any acidic impurity, and reduced in vacuo first on a rotovap and then on a high vacuum line (8 Pa, 24° C.) for 2 hours to yield the final product as a colorless oil (28.1 grams, 85% yield).

### Preparation 21—1-Ethyl-3-methylimidazolium ascorbate [emim] [ascorbate]

1-Ethyl-3-methylimidazolium bicarbonate (1.02 grams of 50% in MeOH/H₂O, Aldrich) was treated with ascorbic acid (0.5247 grams of 98%, Alfa Aesar) at room temperature with stifling. Rapid gas evolution was observed, and the mixture was stirred until completely homogeneous. Solvent was removed under reduced pressure, and the product obtained was a brown gel.

### Preparation 22—1,3-dimethylimidazolium 1,1,2-trifluoro-2-(perfluoroethoxy)ethanesulfonate [mmim][TPES]

### 1,1,2-trifluoro-2-(perfluoroethoxy)ethanesulfonic acid

A 100 ml round bottom flask with a sidearm is equipped with a digital thermometer and a magnetic stirbar and placed in an ice bath under positive nitrogen pressure. To the flask is added 50 grams crude TPES-K (see Preparation 12) along with 30 grams of concentrated sulfuric acid (EM Science, 95-98%) and 78 grams oleum (Acros, 20 wt % SO₃) while stirring. This amount of oleum is chosen so that the SO₃ reacts with and removes the water in the sulfuric acid as well as in the crude TPES-K while still being present in slight excess. The mixing causes a small exotherm which is controlled by the ice bath. Once the exotherm is over, a distillation head with a water condenser is placed on the flask and it is heated under nitrogen behind a safety shield. The pressure is slowly reduced using a PTFE membrane vacuum pump (Buchi V-500) in steps of 100 Ton (13 kPa) in order to avoid foaming. A dry-ice trap is also placed between the distillation apparatus and the pump to collect any excess SO₃. Once the pot temperature reaches 120° C. and the pressure is held at 20-30 Torr (2.7-4.0 kPa) a colorless liquid starts to reflux and later distills at 110° C. and 31 Torr (4.1 kPa). A forerun of lower-boiling impurity (2.0 grams) is obtained before collecting 28 grams of the desired colorless acid, TPES acid.

### 1,3-dimethylimidazolium 1,1,2-trifluoro-2-(perfluoroethoxy)ethanesulfonate [mmim] [TPES]

Mmim bicarbonate (1.0032 grams of 50% in MeOH/H₂O, Aldrich) was treated with TPES acid (0.9432 grams) at room temperature with stirring. Rapid gas evolution was observed, and the mixture was stirred until completely homogeneous. Solvent was removed under reduced pressure, and the product obtained was a yellow gel.

### Preparation 23—Tetramethylammonium tropolonate [TMA] [tropolonate]

Tetramethylammonium hydroxide pentahydrate (0.998 grams of 97%, Aldrich) was dissolved in deionized water (2 mL) and was treated with tropolone (0.673 grams of 98%, Aldrich) at room temperature with stirring until completely homogeneous. Water was removed from the bright yellow solution under reduced pressure, and the product obtained was an orange-brown, viscous semi-solid.

### Preparation 24—Tetramethylammonium levulinate [TMA] [lev]

Tetramethylammonium hydroxide (0.999 grams of 25% in methanol, Aldrich) was treated with levulinic acid (0.314 grams of 98%, Aldrich) at room temperature with stirring until completely homogeneous. Solvent was removed under reduced pressure, and the product obtained was an orange-brown gel.

### Preparation 25 —1-Ethyl-3-methylimidazolium 1,1,2 , 2-tetrafluoroethanesulfonate [emim] [TFES]

To a 500 mL round bottom flask was added 1-ethyl-3-methylimidazolium chloride (emim-Cl, 98%, 61.0 grams, Aldrich) and reagent grade acetone (500 mL). The mixture was gently warmed (50° C.) until almost all of the emim-Cl dissolved. To a separate 500 mL flask was added potassium 1,1,2,2-tetrafluoroethanesulfonate (TFES-K, 90.2 grams, see Preparation 13) along with reagent grade acetone (350 mL). This second mixture was stirred magnetically at 24° C. until all of the TFES-K dissolved. These solutions were combined in a 1 liter flask producing a milky white suspension. The mixture was stirred at 24° C. for 24 hours. The KCl precipitate was then allowed to settle leaving a clear green solution above it.

The reaction mixture was filtered once through a filter aid pad (a diatomaceous earth filtering medium sold under the trademark Celite® from World Minerals, Santa Barbara, Calif.) and again through a fitted glass funnel to remove the KCl. The acetone was removed in vacuo first on a rotovap and then on a high vacuum line (4 Pa, 25° C.) for 2 hours. The product was a viscous light yellow oil (76.0 grams, 64% yield). The reaction scheme is shown below:

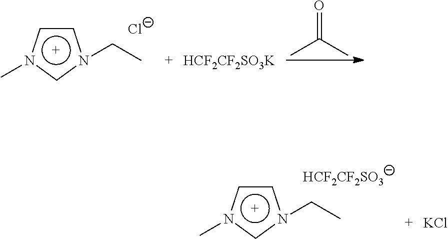

### Preparation 26—Benzyltrimethylammonium phosphonoacetate

Benzyltrimethylammonium hydroxide (1.01 grams of 40% in water, Aldrich) was treated with 2-phosphonoacetic acid (0.33 grams of 98%, Aldrich) at room temperature with stirring until completely homogeneous. Water was removed under reduced pressure, and the product obtained was a white solid.

### Preparation 27—1,3-Dimethylimidazolium levulinate [mmim] [lev]

1,3-dimethylimidazolium bicarbonate (1.01 grams of 50% in MeOH/H₂O, Aldrich) was treated with levulinic acid (0.37 grams of 98%, Aldrich) at room temperature with stirring. Rapid gas evolution was observed, and the mixture was stirred until completely homogeneous. Solvent was removed under reduced pressure, and the product obtained was a viscous liquid.

### Preparation 28 —1-Butyl-3-methylimidazolium 1,1,2,2-tetrafluoroethanesulfonate [bmim] [TFES]

1-Butyl-3-methylimidazolium chloride (60.0 grams, available from Aldrich) and high purity dry acetone (>99.5%, Aldrich, 300 mL) were combined in a 1 liter flask and warmed to reflux with magnetic stirring until the solid completely dissolved. At room temperature in a separate 1 liter flask, potassium-1,1,2,2-tetrafluoroethanesulfonate (TFES-K, 75.6 grams, see Preparation 15) was dissolved in high purity dry acetone (500 mL). These two solutions were combined at room temperature and allowed to stir magnetically for 2 hours under positive nitrogen pressure. The stirring was stopped and the KCl precipitate was allowed to settle, then removed by suction filtration through a fitted glass funnel with a filter aid pad (a diatomaceous earth filtering medium sold under the trademark Celite® from World Minerals, Santa Barbara, Calif.). The acetone was removed in vacuo to give a yellow oil. The oil was further purified by diluting with high purity acetone (100 mL) and stirring with decolorizing carbon (5 grams). The mixture was again suction filtered and the acetone removed in vacuo to give a colorless oil. This was further dried at 4 Pa and 25° C. for 6 hours to provide 83.6 grams of product.

### Preparation 29 —1-octyl-3-methylimidazolium 1,1,2,2-tetrafluoroethanesulfonate

1-Octyl-3-methylimidazolium chloride (available from IoLiTec Ionic Liquids Technologies GmbH & Co. KG, Denzlingen, Germany) and high purity dry acetone (>99.5%, Aldrich, 300 mL) are combined in a 1 liter flask and warmed to reflux with magnetic stirring until the solid is completely dissolved. At room temperature in a separate 1 liter flask, potassium-1,1,2,2-tetrafluoroethanesulfonate (TFES-K, 75.6 grams, see Preparation 15) is dissolved in high purity dry acetone (500 mL). These two solutions are combined at room temperature and allowed to stir magnetically for 2 hours under positive nitrogen pressure. The stirring is stopped and the KCl precipitate is allowed to settle, then removed by suction filtration through a fritted glass funnel with a filter aid pad (a diatomaceous earth filtering medium sold under the trademark Celite® from World Minerals, Santa Barbara, Calif.). The acetone is removed in vacuo to give a yellow oil. The oil is further purified by diluting with high purity acetone (100 mL) and stirring with decolorizing carbon (5 grams). The mixture is again suction filtered and the acetone removed in vacuo to give a colorless oil.

### Preparation 31—Tetradecyl(trihexyl)phosphonium nonafluorobutanesulfonate

To a 500 mL round bottom flask was added acetone (50 mL, spectroscopic grade, EMD) and tetradecyl(trihexyl)phosphonium chloride (33.7 grams, an ionic liquid sold under the trademark Cyphos® IC101, Cytec Industries, Inc., West Paterson, N.J.). This mixture was magnetically stirred at room temperature for 30 minutes. In a separate 500 mL flask, potassium nonafluorobutanesulfonate (17.3 grams, Fluka, >97%) was dissolved in 100 mL acetone. The two solutions were combined with magnetic stirring to produce a white precipitate (KCl).

The precipitate was removed by suction filtration. The solution was concentrated in vacuo to give a cloudy colorless oil. To this oil was added chloroform (100 mL). To remove acidic impurities, this solution was washed once with deionized water (50 mL), two washes with saturated aqueous sodium carbonate (50 mL each), and a final wash with deionized water (50 mL). The chloroform solution was dried over magnesium sulfate and concentrated in vacuo to give a light yellow oil. This material was further dried on a high vacuum line (30 milliTorr, 24° C.) for 8 hours to give 23.4 grams (59% yield).

### Preparation 32—1,3-dimethylimidazolium iodide [mmim] [iodide]

5 grams of N-methylimidazole (may be obtained from Aldrich) was added to a 2 times molar excess of iodomethane (may be obtained from Aldrich). Crystals were formed at room temperature overnight. Excess iodomethane was distilled off using a Rotavap under vacuum. And the product was not recrystallized, but rather was used as is.

### Example 1

### Crystallization Temperature Reduction

A 65.5 to 66.0 weight percent solution of LiBr (Acros Organics anhydrous 99.995%, Alpha Aesar anhydrous, 99.995% metals basis, or Sigma-Aldrich 99.995+% trace metals basis) and water (Sigma-Aldrich for HPLC) was made as follows. The LiBr is measured out in a glove box under nitrogen flow and the appropriate amount of water was added. The mixture was heated to 80° C. until all of the LiBr was dissolved (about 3 hours).

The additive compounds were added in concentrations of ˜1,000 ppm and ˜10,000 ppm (mole basis with respect to LiBr) for 4 grams of LiBr solution. The desired amount of additive was added to a 4 mL glass vial with solid-top, screw-thread closures lined with PTFE-faced 14B white styrene-butadiene rubber (Wheaton # W224582), and about 4 grams of the heated LiBr solution was poured in. Two control samples containing only the LiBr solution were also made. The control samples were poured first and last to ensure that the LiBr concentration was consistent throughout the samples. The vials with the LiBr solution (the two control samples) and LiBr/additive solution were heated at 80° C. overnight while suspended in a constant temperature oil bath (Dow Corning 200®). The samples were cooled first to 50° C., and then in 2-5 degree increments. At each temperature, the vials were allowed to sit for about 10 minutes while the temperature equilibrates. The vials were shaken and then were allowed to sit for another 20-30 minutes to make sure crystallization had not occurred before lowering the temperature further. The temperature where crystallization occurred was recorded for the control samples (LiBr with no additive) and for the LiBr/additive samples as they crystallize. Results are shown in Table 1.

TABLE 1

| | Additive | | | Crystal- |
|---|---|---|---|---|
| | conc. | | Crystal- | lization |
| | (mol | LiBr | lization | temp. |
| | ppm wrt | conc. | temp. | depression |
| Additive | LiBr) | (wt %) | (° C.) | (° C.) |
| None (control sample) | NA | 66 | 47 | NA |
| | | 65.5 | 48 | |
| N,N- | 3315 | 66.2 | 30 | 17 |
| dimethylethanolammonium | 9891 | 66.2 | 30 | 17 |
| acetate | | | | |
| bis(2- | 5102 | 66.2 | 35 | 12 |
| methoxyethyl)ammonium | 14517 | 66.2 | 30 | 17 |
| acetate | | | | |
| N,N- | 4685 | 66.2 | 35 | 12 |
| dimethylethanolammonium | 13220 | 66.2 | 41 | 6 |
| glycolate | | | | |
| N,N- | 4120 | 66.2 | 38 | 10 |
| dimethylethanolammonium | 10275 | 66.2 | 35 | 12 |
| propanoate | | | | |
| tris-(2-hydroxyethyl)- | 2554 | 65.4 | 43 | 5 |
| methylammonium | 11148 | 65.4 | 37 | 11 |
| methylsulfate | | | | |
| choline levulinate | 2226 | 65.4 | 44 | 5 |
| | 11129 | 65.4 | 42 | 6 |
| tetramethylammonium | 5285 | 65.4 | 45 | 3 |
| formate | 19697 | 65.4 | 37 | 11 |
| choline glycolate | 4206 | 66.2 | 45 | 2 |
| | 18150 | 66.2 | 35 | 12 |
| 1-butyl-3- | 1722 | 66.2 | 45 | 2 |
| methylimidazolium acetate | 18251 | 66.2 | 37 | 10 |
| 1-butyl-3- | 1314 | 66.1 | 46 | 2 |
| methylimidazolium | 13151 | 66.1 | 39 | 9 |
| dihydrogen phosphite | | | | |
| 1-ethyl-3- | 1063 | 66.1 | 45 | 2 |
| methylimidazolium | 10005 | 66.1 | 43 | 5 |
| dihydrogen phosphite | | | | |
| lithium acetate dihydrate | 1113 | 66.1 | 46 | 2 |
| | 17422 | 66.1 | 43 | 4 |
| 1-butyl-3- | 1489 | 66.2 | 45 | 2 |
| methylimidazolium | 13081 | 66.2 | 43 | 4 |
| isobutyrate | | | | |
| 1-ethyl-3- | 2238 | 66.2 | 45 | 2 |
| methylimidazolium acetate | 10311 | 66.2 | 43 | 4 |
| 1-butyl-3- | 5675 | 66.2 | 45 | 2 |
| methylimidazolium | 14154 | 66.2 | 43 | 4 |
| propanoate | | | | |
| Tetramethylammonium | 775 | 66.1 | 46 | 1 |
| pyruvate | 3817 | 66.1 | 42 | 5 |
| 1-butyl-3- | 5159 | 66.2 | 46 | 1 |
| methylimidazolium | 12502 | 66.2 | 43 | 4 |
| methylsulfate | | | | |
| 1,2,4-trimethylpyrazolium | 2457 | 65.4 | 48 | 0 |
| methylsulfate | 15005 | 65.4 | 37 | 11 |
| 1-butyl-1- | 2095 | 65.5 | 48 | 0 |
| methylpyrrolidinium | 17386 | 65.5 | 40 | 9 |
| trifluoroacetate | | | | |
| sodium glycolate | 5535 | 65.4 | 49 | 0 |
| | 15056 | 65.4 | 40 | 8 |
| tetramethylammonium | 1201 | 65.4 | 49 | 0 |
| dichloroacetate | 14465 | 65.4 | 42 | 7 |
| tetrabutylphosphonium | 1047 | 65.4 | 49 | 0 |
| succinamate | 11622 | 65.4 | 42 | 6 |
| 1-butyl-3- | 3211 | 65.5 | 48 | 0 |
| methylimidazolium | 8873 | 65.5 | 45 | 3 |
| trifluoroacetate | | | | |
| 1-ethyl-3- | 4901 | 65.5 | 48 | 0 |
| methylimidazolium | 13104 | 65.5 | 45 | 3 |
| trifluoroacetate | | | | |
| diethanolammonium | 869 | 65.5 | 48 | 0 |
| trifluoroacetate | 8198 | 65.5 | 45 | 3 |

Results indicate that the ionic compounds of the present invention provide some degree of crystallization temperature depression for LiBr solutions.

### Example 2

### Crystallization Temperature Reduction

A 65.5 to 66.0 wt % solution of LiBr (Acros Organics anhydrous 99.995%, Alpha Aesar anhydrous, 99.995% metals basis, or Sigma-Aldrich 99.995+% trace metals basis) and water (Sigma-Aldrich for HPLC) was made as follows. The LiBr was measured out in a glove box under nitrogen flow and the appropriate amount of water is added. The mixture was heated to 80° C. until all of the LiBr was dissolved (about 3 hours).

The additive compounds were added in concentrations of ˜1,000 ppm and ˜10,000 ppm (mole basis with respect to LiBr) for 4 grams of LiBr solution. The desired amount of additive is added to a 4 mL glass vial with solid-top, screw-thread closures lined with PTFE-faced 14B white styrene-butadiene rubber (Wheaton # W224582), and about 4 grams of the heated LiBr solution was poured in. Two control samples containing only the LiBr solution were also made. The control samples were poured first and last to ensure that the LiBr concentration is consistent through the samples. In addition, several grains of sand were added to each vial to seed crystallization and reduce supercooling probabilities. The vials with the LiBr solution (the two control samples) and LiBr/additive solutions were heated at 80° C. overnight while suspended in a constant temperature oil bath. The samples were cooled as shown in Table 2 below. The vials were shaken to make sure crystallization had not occurred before lowering the temperature further. The temperature was recorded for the control samples and the LiBr/additive samples as they crystallized. Results are shown in Table 3.

TABLE 2

| Temp, ° C. | Time (minutes) |
|---|---|
| 80 | start |
| 70 | 5 |
| 60 | 5 |
| 55 | 5 |
| 50 | 10 |
| 48 | 5 |
| 46 | 5 |
| 45 | 5 |
| 44 | 5 |
| 43 | 5 |
| 42 | 5 |
| 41 | 5 |
| 40 | 5 |
| 39 | 5 |
| 38 | 5 |
| 37 | 5 |
| 36 | 5 |
| 35 | 5 |
| 34 | 5 |

TABLE 3

| | | | | Crystal- |
|---|---|---|---|---|
| | | | | lization |
| | Addi- | | Crystal- | temp. |
| | tive | LiBr | lization | depres- |
| | conc. | conc. | temp. | sion |
| Additive | (units) | (units) | (° C.) | (° C.) |
| None (control samples) | NA | 65.5 | 44 | NA |
| | | 66.0 | 51 | |
| 1-butyl-3-methylimidazolium | 10000 | 66.0 | 31 | 20 |
| 1,1,2-trifluoro-2- | 10285 | 65.5 | 29 | 15 |
| (perfluoroethoxy)ethanesulfonate | 10513 | 65.5 | 31 | 13 |
| [bmim][TPES] | 10463 | 65.5 | 29 | 15 |
| | 10346 | 65.5 | 29 | 15 |
| 1-(N,N,N- | 5755 | 66.0 | 34 | 18 |
| dimethylpropylaminoethyl)-5- | | | | |
| methylpyrrolidine-2-one | | | | |
| levulinate | | | | |
| [MeDMPAP][Lev] | | | | |
| 1-butyl-3-methylimidazolium | 20995 | 65.5 | 31 | 13 |
| levulinate | | | | |
| [bmim][Lev] | | | | |
| 1-butyl-3-methylimidazolium | 1340 | 66.0 | 38 | 13 |
| 1,1,2,3,3,3- | | | | |
| hexafluoropropanesulfonate | | | | |
| [bmim][HFPS] | | | | |
| choline 1,1,2,2- | 9397 | 65.5 | 33 | 11 |
| tetrafluoroethanesulfonate | | | | |
| [choline][TFES] | | | | |
| Tetradecyl(tri-n- | 1107 | 66.0 | 41 | 10 |
| butyl)phosphonium 1,1,2,3,3,3- | 1219 | 65.5 | 36 | 8 |
| hexafluoropropanesulfonate | 1233 | 65.5 | 34 | 10 |
| [4,4,4,14]P[HFPS] | 1235 | 65.5 | 35 | 9 |
| | 1180 | 65.5 | 35 | 9 |
| 1-butyl-2,3-dimethylimidazolium | 8525 | 66.0 | 41 | 10 |
| 1,1,2,2-tetrafluoroethanesulfonate | | | | |
| [b2mim][TFES] | | | | |
| Tetradecyl(tri-n- | 1023 | 65.5 | 35 | 9 |
| butyl)phosphonium 1,1,2,2- | | | | |
| tetrafluoroethanesulfonate | | | | |
| [4,4,4,14]P[TFES] | | | | |
| 1-butyl-3-methylimidazolium | 868 | 66.0 | 42 | 9 |
| 1,1,2-trifluoro-2- | 9222 | 66.0 | 42 | 9 |
| (trifluoromethoxy)ethanesulfonate | | | | |
| [bmim][TTES] | | | | |
| tetrabutylphosphonium 1,1,2- | 1071 | 65.5 | 37 | 7 |
| trifluoro-2- | | | | |
| (trifluoromethoxy)ethanesulfonate | | | | |
| [TBP][TTES] | | | | |
| 1-ethyl-3-methylimidazolium | 10250 | 65.5 | 38 | 6 |
| ascorbate | | | | |
| [emim][ascorbate] | | | | |
| 1,3-dimethylimidazolium 1,1,2- | 9656 | 65.5 | 38 | 6 |
| trifluoro-2- | | | | |
| (perfluoroethoxy)ethanesulfonate | | | | |
| [mimm][TPES] | | | | |
| tetramethylammonium | 995 | 65.5 | 39 | 5 |
| tropolonate | 9384 | 65.5 | 39 | 5 |
| [TMA][tropolonate] | | | | |
| Tetramethylammonium levulinate | 10236 | 65.5 | 40 | 4 |
| [TMA][Lev] | | | | |
| 1-ethyl-3-methylimidazolium | 10781 | 66.0 | 48 | 3 |
| 1,1,2,2-tetrafluoroethanesulfonate | | | | |
| [emim][TFES] | | | | |
| Benzyltrimethylammonium | 1110 | 65.5 | 42 | 2 |
| phosphonoacetate | 10385 | 65.5 | 40 | 4 |
| [N111benz][phosphonoacetate] | | | | |
| 1,3-dimethylimidazolium | 1386 | 65.5 | 42 | 2 |
| levulinate | 10478 | 65.5 | 42 | 2 |
| [mmim][Lev] | | | | |

Results indicate that the ionic compounds of the present invention provide some degree of crystallization temperature depression for LiBr solutions.

### Example 3

### Crystallization Temperature Reduction

A 65.5 to 66.0 wt % solution of LiBr (Acros Organics anhydrous 99.995%, Alpha Aesar anhydrous, 99.995% metals basis, or Sigma-Aldrich 99.995+% trace metals basis) and water (Sigma-Aldrich for HPLC) is made as follows. The LiBr is measured out in a glove box under nitrogen flow and the appropriate amount of water is added. The mixture is heated to 80° C. until all of the LiBr was dissolved (about 3 hours).

The additive compounds are added in concentrations of 10,000 ppm (mole basis with LiBr) for 4 grams of LiBr solution. The desired amount of additive is added to a 4 mL glass vial with solid-top, screw-thread closures lined with PTFE-faced 14B white styrene-butadiene rubber (Wheaton # W224582), and about 4 grams of the heated LiBr solution is poured in. Two control samples containing only the LiBr solution are also made. The control samples are poured first and last to ensure that the LiBr concentration is consistent through the samples. In addition, several grains of sand are added to each vial to seed crystallization and reduce supercooling probabilities. The vials with the LiBr solution (the two control samples) and LiBr/additive solutions are heated at 80° C. overnight while suspended in a constant temperature oil bath. The samples are cooled as shown in Table 2 for Example 2. The vials are shaken to make sure crystallization has not occurred before lowering the temperature further. The temperature is recorded for the control samples and the LiBr/additive samples as they crystallized. Results are shown in Table 4.

TABLE 4

| | | | Crystallization |
|---|---|---|---|
| | Additive | LiBr | temp. |
| | conc. | conc. | depression |
| Additive | (units) | (units) | (° C.) |
| None | NA | 65.8 | NA |
| 1-octyl-3-methylimidazolium | 10,000 | 65.8 | >1 |
| 1,1,2,2-tetrafluoroethanesulfonate | | | |
| 1-butyl-3-methylimidazolium | 10,000 | 65.8 | >1 |
| 1,1,2,2-tetrafluoroethanesulfonate | | | |
| Tetra(hydroxyethyl)ammonium | 10,000 | 65.8 | >1 |
| 1,1,2,2-tetrafluoroethanesulfonate | | | |
| Tetradecyl(trihexyl)phosphonium | 10,000 | 65.8 | >1 |
| nonafluorobutanesulfonate | | | |
| 1-ethyl-3-methylimidazolium | 10,000 | 65.8 | >1 |
| levulinate [emim][lev] | | | |
| 1-butyl-3-methylimidazolium | 10,000 | 65.8 | >1 |
| levulinate | | | |
| [bmim][Lev] | | | |
| methyltrioctylammonium | 10,000 | 65.8 | >1 |
| trifluoroacetate | | | |
| 1,3-dimethylimidazolium iodide | 10,000 | 65.8 | >1 |

Table 4 indicates that the ionic compounds of the present invention provide some degree of crystallization temperature depression for LiBr solutions.

Representative examples of ionic compounds suitable for use herein include ionic liquids, which are organic compounds that are liquid at room temperature (approximately 25° C.). They differ from most salts in that they have very low melting points, and they tend to be liquid over a wide temperature range. Ionic liquids have essentially no vapor pressure, and they can either be neutral, acidic or basic. The properties of an ionic liquid can be tailored by varying the cation and anion. A cation or anion of an ionic liquid of the invention can in principle be any cation or anion such that the cation and anion together form an organic salt that is liquid at or below about 100° C.

Many ionic liquids are formed by reacting a nitrogen-containing heterocyclic ring, preferably a heteroaromatic ring, with an alkylating agent (for example, an alkyl halide) to form a quaternary ammonium salt, and performing ion exchange or other suitable reactions with various Lewis acids or their conjugate bases to form the ionic liquid. Examples of suitable heteroaromatic rings include substituted pyridines, imidazole, substituted imidazole, pyrrole and substituted pyrroles. These rings can be alkylated with virtually any straight, branched or cyclic C₁₋₂₀ alkyl group, but preferably, the alkyl groups are C₁₋₁₆ groups, since groups larger than this may produce low melting solids rather than ionic liquids. Various triarylphosphines, thioethers and cyclic and non-cyclic quaternary ammonium salts may also been used for this purpose. Counterions that may be used include chloroaluminate; bromoaluminate; gallium chloride, tetrafluoroborate, tetrachloroborate, hexafluorophosphate, nitrate, trifluoromethanesulfonate; methylsulfonate; p-toluenesulfonate; hexafluoroantimonate; hexafluoroarsenate; tetrachloroaluminate; tetrabromoaluminate; perchlorate, hydroxide anion, copper dichloride anion, iron trichloride anion, zinc trichloride anion, as well as various lanthanum, potassium, lithium, nickel, cobalt, manganese, and other metal-containing anions.

Ionic liquids may also be synthesized by salt metathesis, by an acid-base neutralization reaction or by quaternizing a selected nitrogen-containing compound; or they may be obtained commercially from several companies such as Merck (Darmstadt, Germany) or BASF (Mount Olive, N.J.).

Representative examples of ionic liquids useful herein included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references therein cited). In one embodiment, a library, i.e. a combinatorial library, of ionic liquids may be prepared, for example, by preparing various alkyl derivatives of a quaternary ammonium cation, and varying the associated anions. The acidity of the ionic liquids can be adjusted by varying the molar equivalents and type and combinations of Lewis acids.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, an ionic compound, formed by selecting any of the individual cations described or disclosed herein, and by selecting any of the individual anions described or disclosed herein, can be used in an absorption temperature adjustment system. Correspondingly, in yet other embodiments, a subgroup of ionic liquids formed by selecting (i) a subgroup of any size of cations, taken from the total group of cations described and disclosed herein in all the various different combinations of the individual members of that total group, and (ii) a subgroup of any size of anions, taken from the total group of anions described and disclosed herein in all the various different combinations of the individual members of that total group, can be used in an absorption temperature adjustment system. In forming an ionic liquid, or a subgroup of ionic liquids, by making selections as aforesaid, the ionic liquid or subgroup will be identified by, and used in, the absence of the members of the group of cations and/or the group of anions that are omitted from the total group thereof to make the selection; and, if desirable, the selection may thus be made in terms of the members of one or both of the total groups that are omitted from use rather than the members of the group(s) that are included for use. In yet other embodiments, the absorption temperature adjustment system that contains an ionic liquid, or subgroup of ionic liquids, formed by making selections as aforesaid, may also contain any of the other compounds described or disclosed herein.

Each of the formulae shown herein describes each and all of the separate, individual compounds that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, or plurality of compounds, may in such event be characterized by a definition of one or more of the variable radicals, substituents or numerical coefficents that refers to the whole group of the prescribed range for that variable but where the member(s) omitted to form the subgroup are absent from the whole group.

What is claimed is:

1. A composition comprising:
a. lithium bromide;
b. water; and
c. at least one ionic compound comprising at least one cation and at least one anion, wherein the cation is selected from the group consisting of: sodium, potassium, cesium, and cations of the following Formulae: 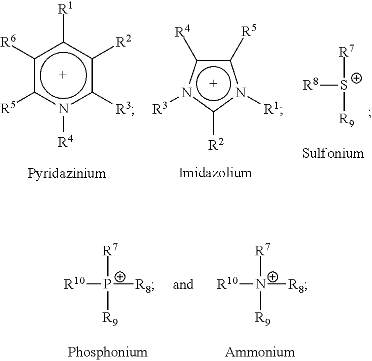
and mixtures thereof;
wherein R¹, R², R³, R⁴, R⁵, and R⁶ are independently selected from the group consisting of:
(i) H,
(ii) halogen,
(iii) —CH₃, —C₂H₅, or C₃ to C₂₅ straight-chain, branched or cyclic alkane or alkene;
(iv) —CH₃, —C₂H₅, or C₃ to C₂₅ straight-chain, branched or cyclic alkane or alkene comprising one to three heteroatoms selected from the group consisting of O, N, Si and S;
(v) C₆ to C₂₀ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and
wherein the substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
(2) OH,
(3) NH₂, and
(4) SH; and
wherein R⁷, R⁸, R⁹, and R¹⁰ are independently selected from the group consisting of:
(i) —CH₃, —C₂H₅, or C₃ to C₂₅ straight-chain, branched or cyclic alkane or alkene;
(ii) —CH₃, —C₂H₅, or C₃ to C₂₅ straight-chain, branched or cyclic alkane or alkene comprising one to three heteroatoms selected from the group consisting of O, N, Si and S,
(iii) C₆ to C₂₅ unsubstituted aryl, or C₃ to C₂₅ unsubstituted heteroaryl having one to three heteroatoms independently selected from the group consisting of O, N, Si and S, and
(iv) C₆ to C₂₅ substituted aryl, or C₃ to C₂₅ substituted heteroaryl having one to three heteroatoms independently selected from the group consisting of O, N, Si and S, and
wherein the substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
(2) OH,
(3) NH₂, and
(4) SH; and
wherein the anion is selected from the group consisting of:
[HCO₂]⁻, [CH₃CO₂]⁻, [HSO₄]⁻, [CH₃OSO₃]⁻, [C₂H₅OSO₃]⁻, [AlCl₄]⁻, [CO₃]², [HCO₃]⁻, [NO₂]⁻, [SO₄]², [PO₃]³, [HPO₃]², [H₂PO₃]¹, [PO₄]³, [HPO₄]², [H₂PO₄][HSO₃]⁻, [CuCl₂]⁻, I⁻, BR¹R²R³R⁴, BOR¹OR²OR³OR⁴, carborates (1-carbadodecaborate(1-)), optionally substituted with alkyl or substituted alkyl, carboranes (dicarbadodecaborate(1-)) optionally substituted with alkylamine, substituted alkylamine, alkyl or substituted alkyl, any fluorinated anion selected from the group consisting of [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂₁CF₂OCF₂CF₂SO₃]⁻, [CF₃CF₂OCF₂CF₂SO₃]⁻, [(CF₂HCF₂SO₂)₂N]_, [(CF₃CFHCF₂SO₂)₂N]⁻, F⁻, and mixtures thereof; and
anions of formula: 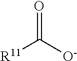
wherein R¹¹ is selected from the group consisting of:
(i) —H, —CH₃, —C₂H₅, or C₃ to C₁₀ straight-chain, branched or cyclic alkane or alkene;
(ii) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₃ to C₁₀unsubstituted heteroaryl having one to three heteroatoms independently selected from the group consisting of O, N, Si and S, and
(iv) C₆ to C₁₀ substituted aryl, or C₃ to C₁₀substituted heteroaryl having one to three heteroatoms independently selected from the group consisting of O, N, Si and S, and
wherein the substituted aryl or substituted heteroaryl has one to three substituents independently selected from the group consisting of:
(1) —CH₃, —C₂H₅, or C₃ to C₁₀ straight-chain, branched or cyclic alkane or alkene,
(2) OH,
(3) NH₂, and
(4) SH;
and mixtures thereof.

2. The composition of claim 1, further comprising at least one additional compound selected from the group consisting of:
salts of bromine; salts of alkali metals, phosphates, chlorates, bromates, iodates, ferrocyanides, chlorides; crown ethers, monocarboxylic acids, polycarboxylic acids, diphosphonic acids, polyphosphoric acids, phosphates; and combinations thereof.

3. The composition of claim 1, further comprising at least one additional compound selected from the group consisting of:
potassium bromate, potassium ferrocyanide, ethylene diamine tetraacetic acid (EDTA), phosphoric acid, malonic acid, malic acid, potassium iodate, adenosine triphosphate (ATP), adenosine diphosphate (ADP), 5-amino-2,4,6-trioxo-1,3-perhydrodizine-N,N-diacetic acid (uramil-N,N-diacetic acid), polyphosphoric acid (poly PA), 1-hydroxyethylidene-1,1-diphosphonic acid (HEDP), diethylene triamine penta(methylene phosphonic acid) (DTPMP), amino tri(methylene phosphonic acid) (ATMP), pyrophosphoric acid (PPA), methylene diphosphonic acid (MDPA), and combinations including one or more of the above.

4. A method for controlling crystallization in a refrigerant fluid comprising water and lithium bromide, the method comprising adding to the refrigerant fluid an ionic compound as listed in claim 1.

5. An absorption cycle apparatus comprising an absorber, a generator, a condenser, an expansion device, and an evaporator wherein the condenser and absorber are air-cooled, and the working fluid comprises the composition of claim 1.

6. The absorption cycle apparatus of claim 5 comprising an absorption chiller.

7. The absorption cycle apparatus of claim 5 comprising an absorption heat pump.

8. A composition comprising:
lithium bromide;
water; and
at least one ionic compound comprising:
at least one cation selected from the group consisting of cations of the following Formulae: 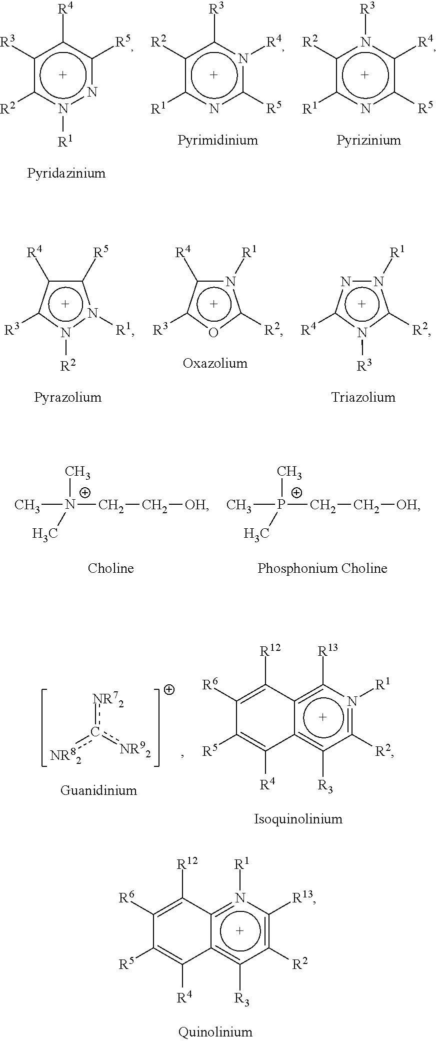
and mixtures thereof;
wherein R¹, R², R³, R⁴, R⁵, R⁶, R¹² and R¹³ are independently selected from the group consisting of:
(i) H,
(ii) halogen,
(iii) —CH₃, —C₂H₅, or C₃ to C₂₅ straight-chain, branched or cyclic alkane or alkene,
(iv) —CH₃, —C₂H₅, or C₃ to C₂₅ straight-chain, branched or cyclic alkane or alkene comprising one to three heteroatoms selected from the group consisting of O, N, Si and S,
(v) C₆ to C₂₀ unsubstituted aryl, or C₃ to C₂₅ unsubstituted heteroaryl having one to three heteroatoms independently selected from the group consisting of O, N, Si and S, and
(vi) C₆ to C₂₅ substituted aryl, or C₃ to C₂₅ substituted heteroaryl having one to three heteroatoms independently selected from the group consisting of O, N, Si and S, and
wherein said substituted aryl or substituted heteroaryl has one to three substituents independently selected from the group consisting of:
(1) —CH₃, —C₂H₅, or C₃ to C₂₅ straight-chain, branched or cyclic alkane or alkene,
(2) OH,
(3) NH₂, and
(4) SH; and
wherein R⁷, R⁸, and R⁹ are independently selected from the group consisting of:
(i) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₂₅ straight-chain, branched or cyclic alkane or alkene comprising one to three heteroatoms selected from the group consisting of O, N, Si and S;
(iii) C₆ to C₂₅ unsubstituted aryl, or C₃ to C₂₅ unsubstituted heteroaryl having one to three heteroatoms independently selected from the group consisting of O, N, Si and S, and
(iv) C₆ to C₂₅ substituted aryl, or C₃ to C₂₅ substituted heteroaryl having one to three heteroatoms independently selected from the group consisting of O, N, Si and S, and
wherein said substituted aryl or substituted heteroaryl has one to three substituents independently selected from the group consisting of:
(1) —CH₃, —C₂H₅, or C₃ to C₂₅ straight-chain, branched or cyclic alkane or alkene,
(2) OH,
(3) NH₂, and
(4) SH.

9. The composition of claim 8 wherein any one of, or any group of more than one of, R¹, R², R³, R⁴, R⁵, R⁶, R⁷, R⁸, R⁹ and R¹⁰ comprises F—.

10. The composition of claim 8 wherein the ionic compound comprises at least one anion selected from the group consisting of [CH₃CO₂]⁻; [HSO₄]⁻; [CH₃OSO₃]⁻; [C₂H₅OSO₃]⁻, [AlCl₄]; [CO₃]²⁻; [HCO₃]; [NO₂]; [NO₃]; [SO₄]²; [PO₃]³; [HPO₃]²; [H₂PO₃]¹⁻; [PO₄]⁻; [HPO₄]²⁻; [H₂PO₄]⁻; [HSO₃]⁻; [CuCl₂]⁻; Cl⁻; Br⁻; I⁻; SCN⁻; BR¹R²R³R⁴; BOR¹OR²OR³OR⁴; carborates (1-carbadodecaborate(1-)) optionally substituted with alkyl or substituted alkyl; carboranes (dicarbadodecaborate(1-)) optionally substituted with alkylamine, substituted alkylamine, alkyl or substituted alkyl; and any fluorinated anion.

11. The composition of claim 8 wherein the fluorinated anion is selected from the group consisting of [BF₄]⁻, [PF₆]⁻, [SbF₆]⁻, [CF₃SO₃]−, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃], [CF₃CFHOCF₂CF₂SO₃]⁻, [CF₂HCF₂OCF₂CF₂SO₃]⁻, [CF₂₁CF₂OCF₂CF₂SO₃], [CF₃CF₂OCF₂CF₂SO₃]⁻, [(CF₂HCF₂SO₂)₂N]₋, [(CF₃CFHCF₂SO₂)₂N]⁻, and F⁻.

12. The composition of claim 8 wherein the ionic compound comprises at least one anion selected from anions of formula: 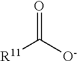
wherein R¹¹ is selected from the group consisting of:
(i) —H, —CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₃ to C₁₀unsubstituted heteroaryl having one to three heteroatoms independently selected from the group consisting of O, N, Si and S, and
(iv) C₆ to C₁₀ substituted aryl, or C₃ to C₁₀ substituted heteroaryl having one to three heteroatoms independently selected from the group consisting of O, N, Si and S; and
wherein said substituted aryl or substituted heteroaryl has one to three substituents independently selected from the group consisting of:
(1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,
(2) OH,
(3) NH₂, and
(4) SH.

13. The composition of claim 8, further comprising at least one additional compound selected from the group consisting of:
salts of bromine; salts of alkali metals, phosphates, chlorates, bromates, iodates, ferrocyanides, chlorides; crown ethers, monocarboxylic acids, polycarboxylic acids, diphosphonic acids, polyphosphoric acids, phosphates; and combinations thereof.

14. The composition of claim 8, further comprising at least one additional compound selected from the group consisting of:
potassium bromate, potassium ferrocyanide, ethylene diamine tetraacetic acid (EDTA), phosphoric acid, malonic acid, malic acid, potassium iodate, adenosine triphosphate (ATP), adenosine diphosphate (ADP), 5-amino-2,4,6-trioxo-1,3-perhydrodizine-N,N-diacetic acid (uramil-N,N-diacetic acid), polyphosphoric acid (poly PA), 1-hydroxyethylidene-1,1-diphosphonic acid (HEDP), diethylene triamine penta(methylene phosphonic acid) (DTPMP), amino tri(methylene phosphonic acid) (ATMP), pyrophosphoric acid (PPA), methylene diphosphonic acid (MDPA), and combinations including one or more of the above.

15. A method for controlling crystallization in a refrigerant fluid comprising water and lithium bromide, said method comprising adding to the refrigerant fluid an ionic compound as listed in claim 8.

16. An absorption cycle apparatus comprising an absorber, a generator, a condenser, an expansion device, and an evaporator wherein the condenser and absorber are air-cooled, and the working fluid comprises the composition of claim 8.

17. The absorption cycle apparatus of claim 8 comprising an absorption chiller.

18. The absorption cycle apparatus of claim 8 comprising an absorption heat pump.

19. A composition comprising:
a. lithium bromide;
b. water; and
c. at least one ionic compound selected from the group consisting of:
N,N-dimethylethanolammonium propanoate;
bis(2-methoxyethyl)ammonium acetate;
choline glycolate;
N,N-dimethylethanolammonium acetate;
1,2,4-trimethylpyrazolium methylsulfate;
tris-(2-hydroxyethyl)-methylammonium methylsulfate;
tetramethylammonium formate;
1-butyl-3-methylimidazolium 1,1,2-trifluoro-2-(perfluoroethoxy)ethanesulfonate;
tetradecyl(tri-n-butyl)phosphonium 1,1,2,3,3,3-hexafluoropropanesulfonate;
1-butyl-3-methylimidazolium levulinate;
1-butyl-3-methylimidazolium dihydrogen phosphite;
1-butyl-3-methylimidazolium methylsulfate;
1-butyl-3-methylimidazolium acetate;
choline levulinate;
1-butyl-1-methylpyrrolidinium trifluoroacetate;
tetramethylammonium dichloroacetate;
sodium glycolate;
tetrabutylphosphonium succinamate;
tetradecyl(tri-n-butyl)phosphonium 1,1,2 , 2-tetrafluoroethanesulfonate;
choline 1,1,2 , 2-tetrafluoroethanesulfonate;
lithium acetate;
tetramethylammonium pyruvate;
N,N-dimethylethanolammonium glycolate;
1-ethyl-3-methylimidazolium dihydrogen phosphite;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoro acetate;
diethanolammonium trifluoro acetate;
1-ethyl-3-methylimidazolium levulinate;
1-ethyl-3-methylimidazolium acetate;
1-butyl-3-methylimidazolium isobutyrate;
1-butyl-3-methylimidazolium propanoate;
1,3-dimethylimidazolium iodide;
1-butyl-3-methylimidazolium trifluoroacetate;
1-ethyl-3-methylimidazolium trifluoroacetate;
methyltrioctylammonium trifluoroacetate;
diethanolammonium trifluoroacetate; 1-ethyl-3-methylimidazolium 1,1,2,2-tetrafluoroethanesulfonate; 1-butyl-2,3-dimethylimidazolium 1,1,2,2-tetrafluoroethanesulfonate; 1-butyl-3-methylimidazolium 1,1,2,3,3,3-hexafluoropropanesulfonate; 1-octyl-3-methylimidazolium 1,1,2,2-tetrafluoroethanesulfonate; 1-butyl-3-methylimidazolium 1,1,2,2-tetrafluoroethanesulfonate;
tetra(hydroxyethyl)ammonium 1,1,2,2-tetrafluoroethanesulfonate;
tetradecyl(trihexyl)phosphonium nonafluorobutanesulfonate;
1-(N,N,N-dimethylpropylaminoethyl)-5-methylpyrrolidine-2-one levulinate;
1-butyl-3-methylimidazolium 1,1,2-trifluoro-2-(trifluoromethoxy)ethanesulfonate;
1,3-dimethylimidazolium levulinate;
1-ethyl-3-methylimidazolium levulinate;
1,3-dimethylimidazolium 1,1,2-trifluoro-2-(perfluoroethoxy)ethanesulfonate;
tetrabutylphosphonium 1,1,2-trifluoro-2-(trifluoromethoxy)ethanesulfonate;
1-ethyl-3-methylimidazolium ascorbate;
tetramethylammonium tropolonate;
trimethylbenzylammonium phosphonoacetate;
tetramethylammonium levulinate; and mixtures thereof.

20. The composition of claim 19, further comprising at least one additional compound selected from the group consisting of:
salts of bromine; salts of alkali metals, phosphates, chlorates, bromates, iodates, ferrocyanides, chlorides; crown ethers, monocarboxylic acids, polycarboxylic acids, diphosphonic acids, polyphosphoric acids, phosphates; and combinations thereof.

21. The composition of claim 19, further comprising at least one additional compound selected from the group consisting of:
potassium bromate, potassium ferrocyanide, ethylene diamine tetraacetic acid (EDTA), phosphoric acid, malonic acid, malic acid, potassium iodate, adenosine triphosphate (ATP), adenosine diphosphate (ADP), 5-amino-2,4,6-trioxo-1,3-perhydrodizine-N,N-diacetic acid (uramil-N,N-diacetic acid), polyphosphoric acid (poly PA), 1-hydroxyethylidene-1,1-diphosphonic acid (HEDP), diethylene triamine penta(methylene phosphonic acid) (DTPMP), amino tri(methylene phosphonic acid) (ATMP), pyrophosphoric acid (PPA), methylene diphosphonic acid (MDPA), and combinations including one or more of the above.

22. A method for controlling crystallization in a refrigerant fluid comprising water and lithium bromide, said method comprising adding to the refrigerant fluid an ionic compound as listed in claim 19.

23. An absorption cycle apparatus comprising an absorber, a generator, a condenser, an expansion device, and an evaporator wherein the condenser and absorber are air-cooled, and the working fluid comprises the composition of claim 19.

24. The absorption cycle apparatus of claim 19 comprising an absorption chiller

25. The absorption cycle apparatus of claim 19 comprising an absorption heat pump.
